(19) United States
(12) Patent Application Publication
(10) Pub. No.: US 2026/0152066 A1
(43) Pub. Date: Jun. 4, 2026

(54) DISPLAY SYSTEM

(71) Applicant: Panasonic Automotive Systems Co., Ltd., Kanagawa (JP)

(72) Inventors: Norihiro IMAMURA, Osaka (JP); Kenji NAGATOMI, Osaka (JP); Yusuke NIHEI, Tokyo (JP); Michihiro YAMAGATA, Osaka (JP); Keiichi MATSUZAKI, Kyoto (JP)

(73) Assignee: Panasonic Automotive Systems Co., Ltd., Kanagawa (JP)

(21) Appl. No.: 19/392,622

(22) Filed: Nov. 18, 2025

(30) Foreign Application Priority Data
Dec. 3, 2024 (JP) 2024-210502
Dec. 3, 2024 (JP) 2024-210534
Dec. 3, 2024 (JP) 2024-210601
Jul. 17, 2025 (JP) 2025-120604

(51) Int. Cl. B60K 35/28; B60K 35/23; G02B 27/01; G06F 3/01; G06F 3/14

(52) U.S. Cl. CPC B60K 35/285; B60K 35/23; G02B 27/0101; G06F 3/013; G06F 3/1423; B60K 2360/167; B60K 2360/21; B60K 2360/23; B60K 2360/741; G02B 2027/013

(57) ABSTRACT

A display system includes: a device that displays a first virtual display image in front of a user; and a controller that controls the device. The device includes: a display element that emits video light that serves as the image; and a reflector that forms the image by reflecting the video light. The display element includes: a whole display area wider than a display area corresponding to a field of view of the reflector; a first area as a reference in the whole display area; and a second area including, in the whole display area: a superimposed section at least partially overlapping the first area; and a non-superimposed section extending beyond the first area. The controller causes the device to be switched between: a first state to form the image only in the first area; and a second state to form the image in the first and second areas.

### CROSS REFERENCE TO RELATED APPLICATIONS

The present application is based on and claims priority of Japanese Patent Application No. 2024-210502 filed on Dec. 3, 2024, Japanese Patent Application No. 2024-210534 filed on Dec. 3, 2024, Japanese Patent Application No. 2024-210601 filed on Dec. 3, 2024, and Japanese Patent Application No. 2025-120604 filed on Jul. 17, 2025.

### FIELD

The present disclosure relates to a display system.

### BACKGROUND

Patent Literature (PTL) 1 discloses an on-vehicle display device for displaying a virtual image overlapping the view outside a vehicle by causing the reflector to reflect the video light projected from an optical unit that is located inside the vehicle and transmits light that has entered from the outside of the vehicle.

### CITATION LIST

### Patent Literature

PTL 1: Japanese Unexamined Patent Application Publication No. 2013-180713

### SUMMARY

The display system described above can be however improved upon.

The present disclosure thus provides a display system capable of improving upon the above related art.

A display system according to an aspect of the present disclosure includes: a first display device that displays a first virtual display image in front of a user in a vehicle; and a controller that controls the first display device. The first display device includes: a display element that emits video light that serves as the first virtual display image; and a reflector that forms the first virtual display image by reflecting the video light from the display element toward the user. The display element includes: a whole display area wider than a display area corresponding to a field of view of the reflector; a first area as a reference in the whole display area; and a second area including, in the whole display area: a superimposed section at least partially overlapping the first area; and a non-superimposed section extending beyond the first area. The controller causes the first display device to be switched between: a first state to form the first virtual display image only in the first area; and a second state to form the first virtual display image in the first area and the second area, or only in the second area.

A display system according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic view showing that a display system according to Embodiment 1 is placed on a vehicle.

FIG. 2 is a cross-sectional view showing a schematic configuration of a first display device according to Embodiment 1.

FIG. 3 is a cross-sectional view showing a schematic configuration of a second display device according to Embodiment 1.

FIG. 4 is an illustration of a display area of a display element according to Embodiment 1.

FIG. 5 is an illustration of an example display in a first state according to Embodiment 1.

FIG. 6 is an illustration of an example display in a second state according to Embodiment 1.

FIG. 7 is an illustration of an example display being switched from the first state to the second state according to Embodiment 1.

FIG. 8 is an illustration of an example display in the second state shown in Variation 1 of Embodiment 1.

FIG. 9 is an illustration of an example display in the second state shown in Variation 2 of Embodiment 1.

FIG. 10 is an illustration of an example display in the second state shown in Variation 3 of Embodiment 1.

FIG. 11 is an illustration of an example display in the second state shown in Variation 4 of Embodiment 1.

FIG. 12 is an illustration of an example display in the second state shown in Variation 5 of Embodiment 1.

FIG. 13 is an illustration of an example display in the second state shown in Variation 6 of Embodiment 1.

FIG. 14 is an illustration of an example display in the second state shown in Variation 7 of Embodiment 1.

FIG. 15 is an illustration of an example display in the second state shown in Variation 8 of Embodiment 1.

FIG. 16 is an illustration of another example display in the second state in Variation 8 of Embodiment 1.

FIG. 17 is an illustration of an example display in the second state shown in Variation 9 of Embodiment 1.

FIG. 18 is a schematic view showing a schematic configuration of a first display device according to Variation 10 of Embodiment 1.

FIG. 19 is a schematic view showing a schematic configuration of a first display device according to Variation 11 of Embodiment 1.

FIG. 20 is a schematic view showing a display system according to Variation 12 of Embodiment 1.

FIG. 21 is an illustration of an example display according to Variation 12.

FIG. 22 is an illustration of an appearance of a first virtual display image and a change in the display area on the display element in a first switching mode according to Embodiment 1.

FIG. 23 is an illustration including a change in the point of view of a user in the first switching mode according to Embodiment 1.

FIG. 24 is an illustration of an appearance of a first virtual display image and a change in the display area on the display element in a second switching mode according to Embodiment 1.

FIG. 25 is an illustration including a change in the point of view of a user in the second switching mode according to Embodiment 1.

FIG. 26 is an illustration of an example display according to Variation 13 of Embodiment 1.

FIG. 27 is a schematic view showing that a display system according to Embodiment 2 is placed on a vehicle.

FIG. 28 is an illustration of an example first eye guiding display according to Embodiment 2.

FIG. 29 is an illustration of an example second eye guiding display according to Embodiment 2.

FIG. 30 is an illustration of an example second eye guiding display according to Variation 1 of Embodiment 2.

FIG. 31 is an illustration of an example third eye guiding display according to Variation 2 of Embodiment 2.

FIG. 32 is an illustration of another example third eye guiding display according to Variation 2 of Embodiment 2.

FIG. 33 is an illustration of further another example third eye guiding display according to Variation 2 of Embodiment 2.

FIG. 34 is an illustration of an example second eye guiding display according to Variation 3 of Embodiment 2.

FIG. 35 is a schematic view showing that a display system according to Embodiment 3 is placed on vehicle C1.

FIG. 36 is a schematic cross-sectional view showing a display device according to Embodiment 3.

FIG. 37 is a plan view showing a virtual display image according to Embodiment 3.

FIG. 38 is a plan view showing an example display when notification information appears in a virtual display image according to Embodiment 3.

FIG. 39 is a plan view showing a concave mirror according to Embodiment 3.

FIG. 40 is a plan view showing a concave mirror according to a variation of Embodiment 3.

FIG. 41A is a plan view showing a display element according to Embodiment 3.

FIG. 41B is a plan view showing a display element according to a variation of Embodiment 3.

FIG. 42A is a plan view showing a virtual display image according to Variation 1 of Embodiment 3.

FIG. 42B is another plan view showing the virtual display image according to Variation 1 of Embodiment 3.

FIG. 42C is further another plan view showing the virtual display image according to Variation 1 of Embodiment 3.

FIG. 43A is a plan view showing example arrangement of a virtual display image according to Variation 2 of Embodiment 3.

FIG. 43B is another plan view showing the example arrangement of the virtual display image according to Variation 2 of Embodiment 3.

FIG. 44 is a plan view showing a virtual display image according to Variation 3 of Embodiment 3.

FIG. 45 is an illustration of a distortion of a virtual display image on a concave mirror according to Variation 3 of Embodiment 3.

FIG. 46A is a schematic view showing an example of a central mirror area, a one-end mirror area, and an other-end mirror area according to Variation 4 of Embodiment 3.

FIG. 46B is a schematic view showing another example of the central mirror area, the one-end mirror area, and the other-end mirror area according to Variation 4 of Embodiment 3.

FIG. 46C is a schematic view showing further another example of the central mirror area, the one-end mirror area, and the other-end mirror area according to Variation 4 of Embodiment 3.

FIG. 46D is a schematic view showing yet another example of the central mirror area, the one-end mirror area, and the other-end mirror area according to Variation 4 of Embodiment 3.

FIG. 47 is an illustration of an example display according to Variation 5 of Embodiment 3.

FIG. 48 is an illustration of an example display according to Variation 6 of Embodiment 3.

### DESCRIPTION OF EMBODIMENTS

### Underlying Knowledge Forming Basis of the Present Disclosure

In recent years, users (i.e., drivers) require a display system whose display mode is switchable depending on the situation. It is an objective of the present disclosure to provide a display system whose display mode is switchable depending on the situation.

(1) A display system according to an aspect of the present disclosure includes: a first display device that displays a first virtual display image in front of a user in a vehicle; and a controller that controls the first display device. The first display device includes: a display element that emits video light that serves as the first virtual display image; and a reflector that forms the first virtual display image by reflecting the video light from the display element toward the user. The display element includes: a whole display area wider than a display area corresponding to a field of view of the reflector; a first area as a reference in the whole display area; and a second area including, in the whole display area: a superimposed section at least partially overlapping the first area; and a non-superimposed section extending beyond the first area. The controller causes the first display device to be switched between: a first state to form the first virtual display image only in the first area; and a second state to form the first virtual display image in the first area and the second area, or only in the second area.

According to the display system described in (1), only the first area displays the first virtual display image in the first state. On the other hand, in the second state, the first area and the second area form the first virtual display image or only the second area forms the first virtual display image. That is, different areas display the first virtual display image between the first state and the second state. Since this first state and the second state are switchable, the display mode is switchable between the first state and the second state, depending on the situation.

(2) In the display system described above in item (1), the second area may extend beyond the first area in at least one of an upward, downward, right, or left direction.

According to the display system described in (2), the second area extends beyond the first area in at least one of the upward, downward, right, or left direction. The second area can be wider than the first area in this direction.

(3) In the display system described above in item (2), the second area may be included in a display area corresponding to a field of view of the reflector.

According to the display system described in (3), the second area is included in the display area corresponding to the field of view of the reflector. What is to be displayed in the second state can thus be included in the display area.

(4) In the display system described above in item (2), the second area may be in a size equal to a size of the display area corresponding to a field of view of the reflector in at least one of a vertical direction or a horizontal direction.

According to the display system described in (4), the second area is in the size equal to the size of the display area corresponding to the field of view of the reflector in at least one of the vertical direction or the horizontal direction. What is to be displayed in the second state can thus be included in the display area and can be made as large as possible.

(5) In the display system described above in item (2), the second area may be in a size over a size of a display area corresponding to a field of view of the reflector in at least one of a vertical direction or a horizontal direction.

According to the display system described in (5), the second area is in the size over the size of the display area corresponding to the field of view of the reflector in at least one of the vertical direction or the horizontal direction. What is to be displayed in the second state can thus be displayed in an enlarged manner in the display area.

(6) In the display system described above in any one of items (1) to (5), the controller may cause the first display device to display a speedometer in the first area in each of the first state and the second state.

According to the display system described in (6), the first area displays the speedometer in each of the first state and the second state, which allows the user to grasp the speed in each of the first state and the second state.

(7) In the display system described above in any one of items (1) to (6), the controller may cause the first display device to display, in the second state: a frame image showing a side mirror frame of the vehicle in the second area; and a rear image showing a rear of the vehicle in an area corresponding to a mirror in the frame image in the second area.

According to the display system described in (7), in the second state, the second area displays the frame image and the rear image, which allows the user to grasp the frame image and the rear image.

(8) In the display system described above in any one of items (1) to (6), the controller may cause the first display device to display, in the second state, a front image showing a front of the vehicle in the second area.

According to the display system described in (8), the second area displays the front image in the second state, which allows the user to grasp the front image.

(9) In the display system described above in any one of items (1) to (6), the controller may cause the first display device to display, in the second state, a pillar image overlapping a surrounding image in the second area, the pillar image showing a pillar of the vehicle, the surrounding image being an image captured by a camera outside the pillar.

According to the display system described in (9), the second area displays the pillar image and the surrounding image in an overlapping manner in the second state, which allows the user to grasp the pillar image and the surrounding video image.

(10) In the display system described above in any one of items (1) to (9), the controller may cause the first display device to be switched from the first state to the second state upon satisfaction of predetermined conditions.

According to the display system described in (10), the switch from the first state to the second state can be made upon satisfaction of the predetermined conditions. The switch to the second state, in which objects are more visible to the user, improves the visibility. The switch from the first state to the second state can notify the user of the satisfaction of the predetermined conditions.

(11) In the display system described above in any one of items (1) to (10), the controller may cause the first display device to execute the switch between the first state and the second state by sliding the first virtual display image.

According to the display system described in (11), the switch between the first state and the second state can be made by sliding the first virtual display image, which allows the user to grasp that the switching is in the middle, by viewing the sliding display.

(12) The display system described above in any one of items (1) to (11) may further include a second display device that displays a second virtual display image in front of the user and above or below the first virtual display image. The controller may cause the first display device and the second display device to display an arrow extending across the first virtual display image and the second virtual display image.

According to the display system described in (12), the arrow is displayed across the first virtual display image and the second virtual display image. This can guide the eyes from the first virtual display image to the second virtual display image, by causing the user to view the arrow.

(13) In the display system described above in item (12), the distance between the first virtual display image and the second virtual display image is within 0.25 diopter in side view of the vehicle.

According to the display system described in (13), the distance between the first virtual display image and the second virtual display image is within 0.25 diopter in side view of the vehicle. This can reduce the amount of focus (i.e., the amount of adjusting the focus of eyes), when the user moves the eyes from the first virtual display image to the second virtual display image.

(14) In the display system described above in any one of items (1) to (13), the reflector may be provided on a windshield of the vehicle.

According to the display system described in (14), the reflector is provided on the windshield, which can reduce the space consumption by the reflector and downsize the system as a whole.

(15) The display system described above in any one of items (1) to (14) may further include: a viewpoint detector that detects a point of view of the user. The controller may cause the first display device to operate in:
the second state, when the point of view detected by the viewpoint detector is within a predetermined area; and the first state, when the point of view detected by the viewpoint detector is out of the predetermined area.

According to the display system described in (15), the first display device is in the second state when the point of view is within the predetermined area, and in the first state when the point of view is out of the predetermined area. The switch between the first state and the second state can be made depending on the point of view.

(16) In the display system described above in item (7), the controller may cause the first display device to display, in the second area, a guide mark for guiding eyes of the user toward a target of attention included in the rear image.

According to the display system described in (16), the second area displays the guide mark for guiding the eyes of the user toward the target of attention included in the rear image. The user can move the eyes to the target of attention by viewing the guide mark. Accordingly, the user can notice the target of attention earlier.

(17) In the display system described above in item (16), the controller may cause the first display device to display the guide mark to gradually approach the target of attention, and display the guide mark in a more emphasized manner with a decreasing distance between the vehicle and the target of attention.

According to the display system described in (17), the guide mark is displayed to gradually approach the target of attention. The guide mark can be expressed like an animation, which allows the user to notice the guide mark more easily. In addition, the guide mark is displayed in a more emphasized manner with the decreasing distance between the vehicle and the target of attention, which can notify the user of the fact that the distance to the target of attention is decreasing.

(18) In the display system described above in item (17), the controller may cause the first display device to return the guide mark to an initial position after the guide mark has come close to the target of attention, and display the guide mark to approach the target of attention again.

According to the display system described in (18), the guide mark returns to the initial position after coming close to the target of attention, and is displayed to approach the target of attention again. That is, the guide mark repeats the approach to the target of attention, which allows the user to notice the guide mark.

(19) The display system described above in any one of items (1) to (18) may further include: a second display device that displays a second virtual display image in front of the user and above the first virtual display image; and an image capturer that captures an image of surroundings of the vehicle. The controller may control the second display device and the image capturer. The controller may cause: the first display device to display, in the first virtual display image, vehicle surrounding information obtained by the image capturer; and the second display device to display, in the second virtual display image, first guide information for encouraging guiding of eyes to the first virtual display image. The controller may subsequently cause: the first display device to display, in the first virtual display image, second guide information for encouraging guiding of eyes to the front of the vehicle.

According to the display system described in (19), the vehicle surrounding information is displayed in the first virtual display image, and the first guide information for encouraging the guiding of eyes to the first virtual display image is displayed in the second virtual display image. The second guide information for encouraging the guiding of eyes to the front of the vehicle is then displayed in the first virtual display image. Since the second guide information is displayed in the first virtual display image in this manner, the user moves the eyes to the front of the vehicle after viewing the second guide information. This can reduce continuous viewing of the first virtual display image and increase the safety in the safety confirmation.

(20) In the display system described above in item (19), when displaying the second guide information in the first virtual display image, the controller may cause the second display device to display, in the second virtual display image, third guide information for encouraging the guiding of eyes to the front of the vehicle.

According to the display system described in (20), when the second guide information is displayed in the first virtual display image, the third guide information for encouraging the guiding of eyes to the front of the vehicle is also displayed in the second virtual display image. The second guide information and the third guide information can guide the eyes of the user to the font of the vehicle. This can increase the safety in the safety confirmation.

(21) In the display system described above in item (19), the controller may cause the second display device to display the third guide information in the second virtual display image to guide the eyes to a target of attention in front of the vehicle.

According to the display system described in (21), the third guide information is displayed in the second virtual display image so as to guide the eyes onto the target of attention in front of the vehicle. The third guide information can thus guide the eyes of the user to the target of attention. This can increase the safety in the safety confirmation.

(22) In the display system described above in item (20) or (21), the controller may cause the second display device to display, in the second virtual display image, text information for assisting the guiding of the eyes, together with the third guide information.

According to the display system described in (22), together with the third guide information, the text information for assisting the guiding of the eyes is also displayed in the second virtual display image. The user can move the eyes to the target of attention more easily, by viewing the third guide information and the text information.

(23) In the display system described above in any one of items (20) to (22), the controller may cause the second display device to highlight-display an end of the second virtual display image as the third guide information.

According to the display system described in (23), as the third guide information, the end of the second virtual display image is highlight-displayed. The user can move the eyes to the target of attention, by viewing the highlight-display.

(24) In the display system described above in any one of items (19) to (23), when displaying the second guide information in the first virtual display image, the controller may cause the first display device not to display the vehicle surrounding information in the first virtual display image.

According to the display system described in (24), when the second guide information is displayed in the first virtual display image, the vehicle surrounding information is not displayed in the first virtual display image. The user can thus concentrate on the second guide information.

(25) In the display system described above in any one of items (20) to (23), when displaying at least one of the second guide information or the third guide information, the controller may cause the first display device to display the vehicle surrounding information in the first virtual display image.

According to the display system described in (25), when at least one of the second guide information or the third guide information is displayed, the vehicle surrounding information is also displayed in the first virtual display image. Accordingly, the user can move the eyes based on at least of the second guide information or the third guide information, while checking the vehicle surrounding information.

(26) In the display system described above in any one of items (19) to (25), when determining that a target of attention in front of the vehicle is not in a blind spot for the user based on the vehicle surrounding information, the controller may cause the first display device not to display the vehicle surrounding information in the first virtual display image.

According to the display system described in (26), when the target of attention in front of the vehicle is determined not to be included in the blind spot for the user, the vehicle surrounding information is not displayed in the first virtual display image. This can reduce unintended display of the vehicle surrounding information in the first virtual display image. Accordingly, the user can concentrate on viewing the front of the vehicle.

(27) In the display system described above in any one of items (19) to (25), the controller may cause the first display device not to display the vehicle surrounding information in the first virtual display image, when the speed of the vehicle reaches a certain speed or more.

According to the display system described in (27), when the speed of the vehicle reaches the certain speed or more, the vehicle surrounding information is not displayed in the first virtual display image. That is, the vehicle surrounding information is not displayed in the first virtual display image, when the user has to concentrate on driving (e.g., at a high speed). That is, the user can concentrate on viewing the front of the vehicle.

(28) In the display system described above in any one of items (19) to (25), the controller may cause the first display device not to display the vehicle surrounding information in the first virtual display image, when the vehicle surrounding information is displayed for a certain period of time.

According to the display system described in (28), after being displayed for the certain period of time, the vehicle surrounding information is no more displayed in the first virtual display image. This can reduce the display of the vehicle surrounding information in the first virtual display image for a long time. Accordingly, the user can concentrate on viewing the front of the vehicle.

(29) In the display system described above in any one of items (1) to (28), in the first virtual display image, a first height in a central area in a vehicle transverse direction of the vehicle may be different from a second height in a one-end area and an other-end area in the vehicle transverse direction.

According to the display system described in (29), the first height in the central area and the second height in the one-end area and the other-end area are different in the first virtual display image. This allows the user to recognize the virtual image displayed in the central area and the virtual images displayed in the one-end area and the other-end area as different virtual images. That is, the first virtual display image projected by one first display device can be recognized by the user as a plurality of virtual images, which can reduce an increase in the size of the whole system. In addition, the virtual image displayed in the central area and the virtual images displayed in the one-end area and the other-end area are included in the first virtual display image. This reduces the movement of the eyes of the user and the focus adjustment. Further, the first height in the central area and the second height in the one-end area and the other-end area are different in the first virtual display image. As compared to a display area in a rectangular shape as a whole, the user can grasp the first virtual display image displayed on the one-end area and the other-end area, while distinguishing the end areas from the central area. Accordingly, the eyes of the user is less likely to blocked. This can reduce the psychological burden on the user. From the forgoing, a display system causing less burden on the user can be provided, while reducing an increase in the size of the whole system.

(30) In the display system described above in item (29), the controller may cause the first display device to display a side image showing a side of the vehicle in each of the one-end area and the other-end area in the first virtual display image.

According to the display system described in (30), each of one-end area and other-end area displays a side image showing the corresponding side of the vehicle. This allows the side image to be displayed as a virtual image and the user to recognize the image.

(31) In the display system described above in item (29) or (30), the second height may be greater than the first height.

According to the display system described in (31), the second height is greater than the first height. When being displayed in the one-end area or the other-end area, the side image can be displayed largely in the height direction. Accordingly, the user can easily check the side image.

(32) In the display system described above in any one of items (29) to (30), the one-end area and the other-end area in the first virtual display image may have, in the vehicle transverse direction, a length greater than a length of the central area in the vehicle transverse direction.

According to the display system described in (32), in the first virtual display image, the length of the one-end area and the other-end area in the vehicle transverse direction is greater than the length of the central area in the vehicle transverse direction. When being displayed in the one-end area or the other-end area, the side images can be displayed largely in the vehicle transverse direction. Accordingly, the user can easily check the sides image.

(33) In the display system described above in any one of items (29) to (32), one of the one-end area or the other-end area in the first virtual display image may be farther from a center of the user in the vehicle transverse direction than the other is.

According to the display system described in (33), one of the one-end area or the other-end area in the first virtual display image is farther from the center of the user in the vehicle transverse direction than the other is. For the user, the one is displayed in a more biased manner than the other. That is, the one-end area and the other-end area can be are arranged at proper positions in a vehicle, depending on whether the vehicle is a left-handle vehicle or a right-handle vehicle.

(34) In the display system described above in any one of items (29) to (33), the one-end area and the other-end area in the first virtual display image may overlap a horizontal line passing through a center of a height of the central area.

According to the display system described in (34), the one-end area and the other-end area in the first virtual display image overlap the horizontal line passing through the center of the height of the central area. This allows the eyes of the user to move linearly, when the user views around the whole first virtual display image, which can reduce the burden on the user.

(35) In the display system described above in item (34), the one-end area and the other-end area in the first virtual display image may protrude more downward than the central area does.

According to the display system described in (35), the one-end area and the other-end area in the first virtual display image protrude more downward than the central area does. Accordingly, the steering is located between these downward protrusions of the one-end area and other-end area beyond the central area, that is, the non-display area. This can reduce the blockage of the first virtual display image by the steering.

(36) In the display system described above in item (35), the first virtual display image may have a lower end in a shape along an upper shape of a steering of the vehicle.

According to the display system described in (36), the first virtual display image has the lower end in the shape along the upper shape of the steering. This can reduce the area to be blocked by the steering and make the first virtual display image as large as possible.

(37) In the display system described above in any one of items (29) to (36), the first display device may further include: a display element that generates the video light that serves as the first virtual display image; and an optical system that reflects the video light emitted from the display element to form the first virtual display image. The optical system may include a final reflective surface that is a concave mirror. In the concave mirror, a first mirror height in a central mirror area in the vehicle transverse direction may be different from a second mirror height in a one-end mirror area and an other-end mirror area in the vehicle transverse direction.

According to the display system described in (37), in the concave mirror, the first mirror height in the central mirror area may be different from the second mirror height in the one-end mirror area and the other-end mirror area. Without employing any special display element, the shape of the first virtual display image can be achieved by the shape of the concave mirror.

(38) In the display system described above in item (37), the concave mirror may have an upper end curved in a convex shape.

The video light from the display element is distorted when being reflected by the concave mirror. When the concave mirror has the upper end curved in the convex shape as in the display system in (38), the concave mirror can be made in a shape in view of this distortion.

(39) In the display system described above in item (37) or (38), the concave mirror may be divided into the central mirror area, the one-end mirror area, and the other-end mirror area.

According to the display system described in (39), being divided into the central mirror area, the one-end mirror area, and the other-end mirror area, the concave mirror can be manufactured easily, as compared to a concave mirror with an integral body.

(40) In the display system described above in item (39), the central mirror area, the one-end mirror area, the other-end mirror area may be held by one holding member.

According to the display system described in (40), the central mirror area, the one-end mirror area, and the other-end mirror area, which are separate bodies, are held by the one holding member. This can hold the central mirror area, the one-end mirror area, and the other-end mirror area stably, and reduce the displacement of the optical axis in each area.

(41) In the display system described above in item (39) or (40), each of the one-end mirror area and the other-end mirror area may have a curvature greater than a curvature of the central mirror area.

According to the display system described in (41), each of the one-end mirror area and the other-end mirror area may have the curvature greater than the curvature of the central mirror area. This can make the one-end area and the other-end area in the first virtual display image larger than the central area.

(42) In the display system described above in any one of items (39) to (41), the concave mirror may be included in a windshield of the vehicle.

According to the display system described in (42), the concave mirror is included in the windshield of the vehicle. The windshield can be used as a part of the optical system, which can downsize the system as a whole.

(43) In the display system described above in any one of items (29) to (42), the first display device may further include: a display element that generates the video light that serves as the first virtual display image; and an optical system that reflects the video light emitted from the display element to form the first virtual display image. The display element is divided into: a central element corresponding to the central area in the first virtual display image; and a pair of end elements corresponding to the one-end area and the other-end area in the first virtual display image.

According to the display system described in (43), the display element is divided into the central element corresponding to the central area in the first virtual display image, and the pair of end elements corresponding to the one-end area and the other-end area in the first virtual display image. Accordingly, the central element and the pair of end elements with simple outer shapes can be used.

(44) In the display system described above in any one of items (29) to (43), the controller may cause the first display device to display a meter image in each of the one-end area and the other-end area in the first virtual display image in normal driving, and a side image showing a side of the vehicle in each the one-end area and the other-end area in the first virtual display image when notification information appears.

According to the display system described in (44), each of the one-end area and the other-end area in the first virtual display image displays the meter image in normal driving. On the other hand, when the notification information appears, each of the one-end area and the other-end area in the first virtual display image displays the side image. This can reduce the troubles of the side image displayed in each of the one-end area and the other-end area in normal driving.

(45) In the display system described above in any one of items (29) to (43), the controller may cause the first display device to turn off the one-end area and the other-end area in the first virtual display image in normal driving, and to display a side image showing a side of the vehicle in each of the one-end area and the other-end area in the first virtual display image when notification information appears.

According to the display system described in (45), the one-end area and the other-end area in the first virtual display image are turned off in normal driving. This can reduce the troubles of the virtual images displayed in the one-end area and the other-end area in normal driving.

(46) In the display system described above in any one of items (29) to (43), the controller may cause the first display device to display the side image showing the side of the vehicle in each of the one-end area and the other-end area in the first virtual display image, and to display a rear image showing a rear of the vehicle in the central area.

According to the display system described in (46), each of the one-end area and the other-end area in the first virtual display image displays the side image showing the side of the vehicle, and the central area displays the rear image. The side images and the rear image can be displayed in a list, which allows the user to grasp these images at once.

(47) In the display system described above in any one of items (29) to (43), the controller may cause the first display device to display the side images as seen from the locations of the one-end area and the other-end area in the first virtual display image, in the one-end area and the other-end area.

According to the display system described in (47), the one-end area and the other-end area in the first virtual display image display the side images as seen from the locations of the one-end area and the other-end area. This can display the side images less strange for the user.

(48) In the display system described above in any one of items (29) to (43), the controller may cause the first display device to display the side image after being overlapped in a translucent manner by an interior image imitating an interior of the vehicle.

According to the display system described in (48), the side image is displayed after being overlapped by the translucent interior image. This allows the user to intuitively grasp the positional relationship between the target of attention included in the side image and the interior.

### Embodiments

Now, embodiments will be described in detail with respect to the drawings. Note that the embodiments described below are mere specific examples of the present disclosure. The numerical values, shapes, materials, elements, the arrangement and connection of the elements, steps, step orders etc. shown in the following embodiments are thus mere examples, and are not intended to limit the scope of the present disclosure. Among the elements illustrated in the following embodiments, those not recited in the independent claims which embody the broadest concept of the present disclosure will be described as optional.

The optical paths shown in the drawings in the following embodiments represent the basic concepts and do not necessarily reflect the actual optical paths.

### Embodiment 1

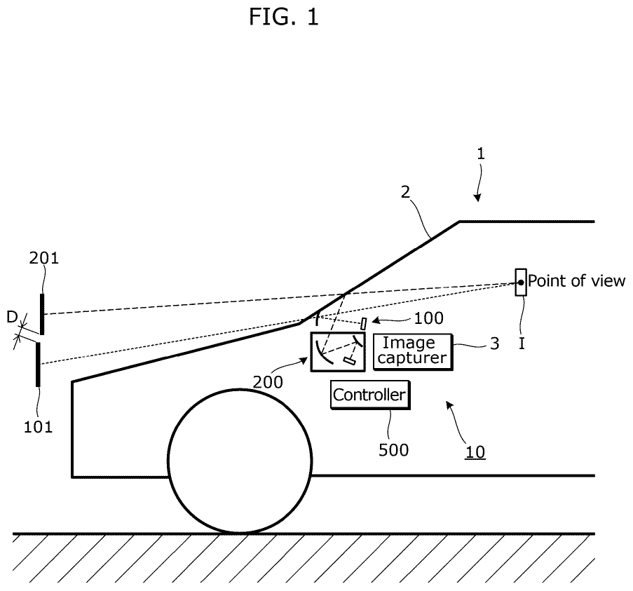

FIG. 1 is a schematic view showing that display system 10 according to Embodiment 1 is placed on vehicle 1. FIG. 1 shows vehicle 1 in a cross section. As shown in FIG. 1, display system 10 includes first display device 100, second display device 200, and controller 500. First display device 100 is located in the dashboard of vehicle 1, and second display device 200 is located below first display device 100. Second display device 200 may be located inside or outside the dashboard. First display device 100 and second display device 200 project, for example, the vehicle information on vehicle 1 as first virtual display image 101 and second virtual display image 201, respectively. Examples of the vehicle information include the vehicle speed of vehicle 1, the revolution per minute (RPM) of the engine, results of detecting objects approaching vehicle 1, and navigation information from the current location to the destination of vehicle 1.

### First Display Device

As shown in FIG. 1, first display device 100 projects video light toward the driver. The driver grasps the video light, which has entered the eyes, as first virtual display image 101 projected far away from first display device 100. In this manner, first display device 100 is an example of the first display device that projects virtual image in front of the driver.

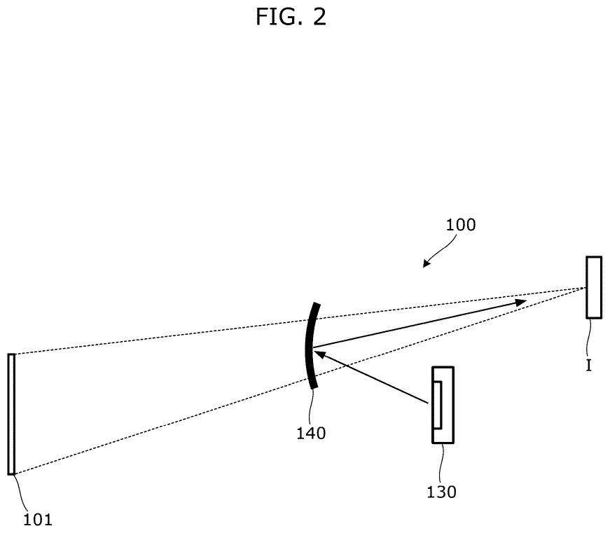

FIG. 2 is a cross-sectional view showing a schematic configuration of first display device 100 according to Embodiment 1. As shown in FIG. 2, first display device 100 includes display element 130 and reflector 140.

Display element 130 is a liquid crystal panel, for example. Once a light source (not shown) projects light, display element 130 displays an image, which is the origine of first virtual display image 101, and projects the video light of the image toward reflector 140. Display element 130 may be an organic electroluminescent (EL) panel. Display element 130 is oriented with the display surface facing the front of vehicle 1.

Reflector 140 is located in front of display element 130, reflects the video light emitted from display element 130, to form first virtual display image 101. Reflector 140 is a concave mirror, for example, and is oriented to reflect the video light emitted from display element 130 toward the driver. That is, the video light reflected by reflector 140 heads for the eyes of the eyes of the driver on the driver's seat, as first virtual display image 101. FIG. 1 shows a location of first virtual display image 101 seen from the driver's point of view. This location can be set by adjusting the viewing distance of the video light projected from display element 130 of first display device 100. The viewing distance extends from the driver's point of view to the point of imaging a virtual image (e.g., first virtual display image 101). The driver's point of view is the reference point of eyes, for example. The reference point of eyes represents the position of the eyes of the driver in normal driving. The reference point of eyes depends on the driver's physique and posture. Even if the reference point of eyes varies, the area covering most of the reference point of eyes is referred to as eye box I of vehicle 1. Eye box I is a three-dimensional virtual area.

### Second Display Devic

Second display device 200 is an augmented reality head-up display (AR-HUD). Second display device 200 projects video light onto windshield 2 of vehicle 1. The projected video light is reflected by windshield 2. This reflected light heads for the eyes of the driver, who is the user, on the driver's seat.

The driver grasps the reflected light, which has entered the eyes, as second virtual display image 201 seen on the opposite side of windshield 2 (i.e., outside the vehicle) with a real object seen through windshield 2 in the background. In this manner, second display device 200 projects a virtual image in front of the driver in vehicle 1. Specifically, second display device 200 projects second virtual display image 201 in front of the driver and above first virtual display image 101.

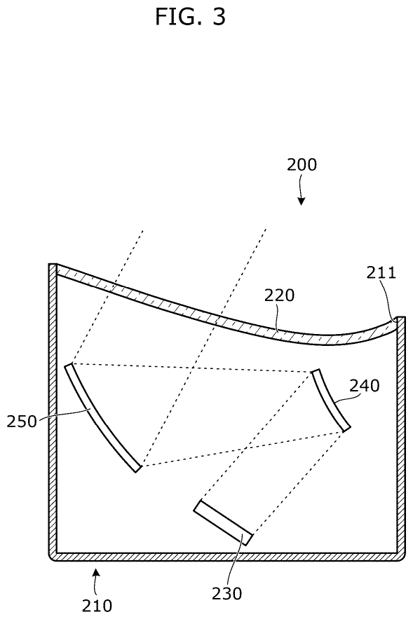

FIG. 3 is a cross-sectional view showing a schematic configuration of second display device 200 according to Embodiment 1. As shown in FIG. 3, second display device 200 includes case 210, cover 220, display element 230, first optical element 240, and second optical element 250.

Case 210 is a box-shaped body made of a light-shielding resin or metal. Specifically, case 210 has a substantially rectangular parallelepiped shape with opening 211 at the top. Opening 211 is closed by cover 220. The internal space of case 210 and cover 220 houses display element 230, first optical element 240, and second optical element 250.

Cover 220 is a curved plate body made of a translucent resin or glass, for example. Specifically, cover 220 has a shape raised downward as a whole.

Display element 230 is a liquid crystal panel, for example. Once a light source (not shown) projects light, display element 230 displays an image, which is the origin of second virtual display image 201, and projects the video light of the image toward first optical element 240. Display element 230 may be an organic EL panel. Display element 230 is in a rectangular shape in plan view and is inclined from the horizontal plane.

First optical element 240 is located on the optical path of the video light emitted from display element 230 and reflects the video light toward second optical element 250. First optical element 240 is a convex mirror in a rectangular shape in plan view. First optical element 240 is inclined from the vertical plane. The reflective surface of first optical element 240 faces display element 230 and second optical element 250.

Second optical element 250 is located on the optical path of the video light that has passed through first optical element 240, and reflects the video light reflected by first optical element 240 toward opening 211. Specifically, second optical element 250 is a concave mirror in a rectangular shape in plan view. Second optical element 250 faces the reflective surface of first optical element 240 and is inclined from the vertical plane of case 210. The reflective surface of second optical element 250 faces first optical element 240 and cover 220. The video light reflected by second optical element 250 is projected onto windshield 2 through opening 211. This reflection causes the video light to head for the eyes of the driver on the driver's seat and serves as second virtual display image 201. FIG. 1 shows a location of second virtual display image 201 seen from the driver's point of view. This location can be set by adjusting the viewing distance of the video light projected from display element 230 of second display device 200.

Here, as shown in FIG. 1, distance D between first virtual display image 101 and second virtual display image 201 may be within 0.25 diopter in side view of vehicle 1. “Diopter” is defined as the absolute value of the difference between the reciprocal of the distance from the point of view to first virtual display image 101 and the reciprocal of the distance from the point of view to second virtual display image 201. In this manner, the distance between first virtual display image 101 and second virtual display image 201 is within 0.25 diopter. This can reduce the amount of focus, when the driver moves the eyes from first virtual display image 101 to second virtual display image 201.

### Controller

As shown in FIG. 1, controller 500 is electrically connected to first display device 100 and second display device 200 and controls these devices. Specifically, controller 500 includes a central processing unit (CPU), a random-access memory (RAM), and a read-only memory (ROM), for example, and executes various processing by the CPU developing and executing, in the RAM, the programs in the ROM.

Controller 500 is communicably connected to image capturer 3, which is included in vehicle 1 and captures an image of the surroundings of vehicle 1, through wired or wireless communication. The image capturer may be included in display system 10.

The image capturer includes a front camera for capturing an image of the front of vehicle 1, a rear camera for capturing an image of the rear of vehicle 1, a right rear camera for capturing an image of the right rear of vehicle 1, a left rear camera for capturing an image of the left rear of vehicle 1, a right side camera for capturing an image of the right side of vehicle 1, a left side camera for capturing an image of the left side of vehicle 1, and other suitable cameras. The images captured by the front camera are included in the front images. The images (i.e., rear images) captured by the rear camera, the images (i.e., right rear images) captured by the right rear camera, and the images (i.e., left rear images) captured by the left rear camera are all included in rear images showing the rear of vehicle 1. The images (i.e., right side images) captured by the right side camera and the images (i.e., left side images) captured by the left side camera are all included in side images showing the sides of vehicle 1.

Controller 500 causes first display device 100 to display at least some of the front images, the rear images, and the side images, and the vehicle information in first virtual display image 101.

On the other hand, controller 500 causes second display device 200 to display the vehicle speed of vehicle 1, navigation information, and other suitable information in second virtual display image 201. The navigation information includes an arrow for guiding the direction of traveling and an attention mark representing the appearance of a target of attention.

### Example Display

Here, when first display device 100 displays first virtual display image 101, controller 500 can switch the display between a first state and a second state. Display element 130 uses different areas between the first state and the second state.

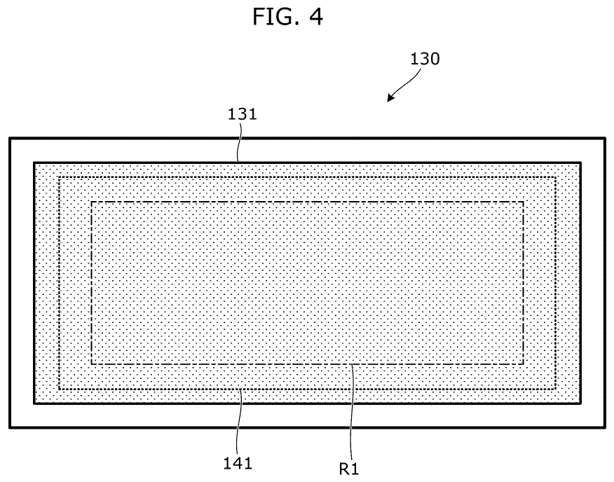

FIG. 4 is an illustration of a display area of display element 130 according to Embodiment 1. As shown in FIG. 4, the dotted area in a rectangular shape represents whole display area 131 of display element 130. In whole display area 131, the dashed line represents display area 141 corresponding to the field of view of reflector 140. Display area 141 is in a rectangular shape, smaller than whole display area 131, and has the same center as whole display area 131.

In whole display area 131, first area R1 as a reference is set within display area 141. First area R1 is represented by the dash-dotted line in FIG. 4, smaller than display area 141, and has the same center as display area 141. In the first state, light is emitted from first area R1 only and reflected by display area 141 so as to form first virtual display image 101.

When first virtual display image 101 is formed from the light emitted from this first area R1 only, whole first virtual display image 101 is visible from the driver's point of view in eye box I. On the other hand, in whole display area 131, even when an image is displayed outside display area 141, the video light fails to reach the driver's point of view in eye box I and invisible to the driver.

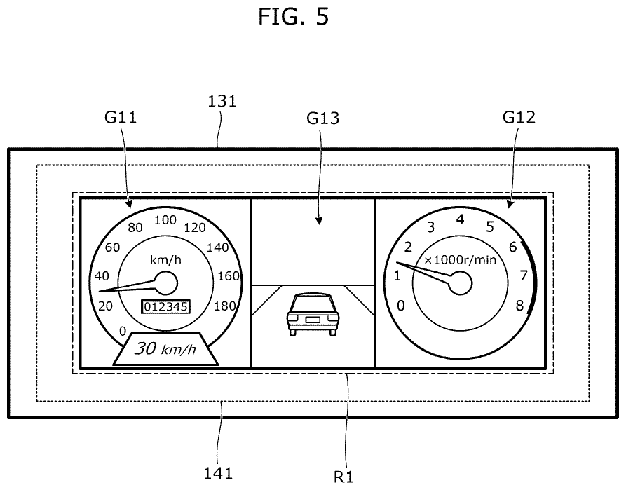

FIG. 5 is an illustration of an example display in the first state according to Embodiment 1. FIG. 5 shows the outer shapes of whole display area 131, display area 141, and first area R1, which are not displayed actually. As shown in FIG. 5, in the first state, first area R1 displays speedometer G11 on the left, tachometer G12 on the right, and own vehicle image G13 at the center. This example display is projected, as first virtual display image 101, in front of the driver. From the driver's point of view in eye box I, whole first virtual display image 101 is visible.

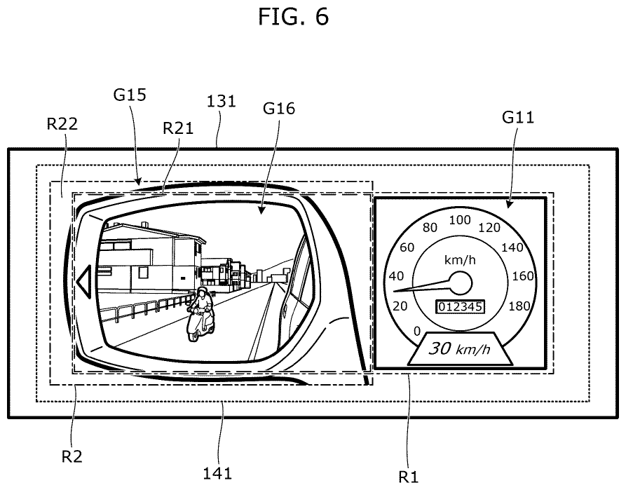

FIG. 6 is an illustration of an example display in the second state according to Embodiment 1. FIG. 6 shows the outer shapes of whole display area 131, display area 141, first area R1, and second area R2, which are not displayed actually. As shown in FIG. 6, in the second state, first area R1 and second area R2 form first virtual display image 101. Second area R2 is represented by the two-dot-dash line in FIG. 6. Here, second area R2 includes superimposed area R21 partially overlapping first area R1, and non-superimposed area R22 extending beyond first area R1. Superimposed area R21 overlaps substantially the left half of first area R1. Non-superimposed area R22 extends beyond first area R1 in at least one of the upward, downward, right, or left direction. Specifically, non-superimposed area R22 extends beyond first area R1 in the upper, lower, and left directions. Second area R2 is included in display area 141.

In the example display shown in FIG. 6, first area R1 displays speedometer G11 on the right, and second area R2 displays frame image G15 and rear image G16. Specifically, frame image G15 shows a side mirror frame of vehicle 1. Frame image G15 may be a computer graphic (CG) image, an illustration image, an image obtained by actually capturing an image of the frame, or any other suitable image. Part of frame image G15 is also displayed in non-superimposed area R22 and displayed more largely than first area R1 in the vertical direction. Rear image G16 is a rear image of vehicle 1 captured with reference to the frame and included in the area corresponding to a mirror in frame image G15. In this manner, in the second state, frame image G15 is displayed more largely than first area R1 in the vertical direction. This allows the driver to intuitively grasp the switch to the second state, without checking the details of the display. In addition, rear image G16 can be displayed more largely than in the case of displaying whole frame image G15 only in first area R1, which allows the driver to easily view rear image G16.

Here, upon satisfaction of predetermined conditions, controller 500 causes first display device 100 to be switched from the first state to the second state. Examples of the predetermined conditions include that the speed of vehicle 1 reaches a predetermined speed or more/less, that the distance between vehicle 1 and a target of attention reaches a predetermined distance or less, and that the driver operates a switch button. The fact that the distance between vehicle 1 and the target of attention reaches the predetermined distance or less can be detected as follows. For example, by processing the front images, the rear images, and the side images obtained by image capturer 3, the distance between the target of attention included in these images and vehicle 1 can be detected. In addition, the distance between vehicle 1 and the target of attention can also be detected using a ranging sensor, such as a radar and light detection and ranging (LiDAR), of vehicle 1.

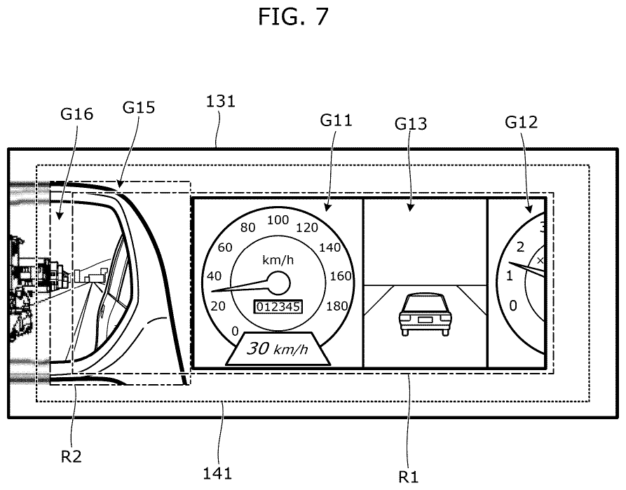

Controller 500 causes first display device 100 to execute the switch between the first state and the second state by sliding first virtual display image 101. FIG. 7 is an illustration of an example display being switched from the first state to the second state according to Embodiment 1. Controller 500 causes first display device 100 to slide the example display in the first state shown in FIG. 5 to the right so that frame image G15 and rear image G16 gradually enter second area R2 from the left end as shown in FIG. 7. This gradually progresses so that the display shifts to the second state as in the example display shown in FIG. 6.

### Advantages

As described above, according to the embodiment described above, only first area R1 displays first virtual display image 101 in the first state. On the other hand, in the second state, first area R1 and second area R2 form the first virtual display image. That is, the different areas display first virtual display image 101 between the first state and the second state. Since the display is switchable between this first state and the second state, the display mode is switchable between the first state and the second state, depending on the situation.

In the second state, only second area R2 may form first virtual display image 101, without displaying speedometer G11 other than digital display.

Since second area R2 extends beyond first area R1 in at least one of the upward, downward, right, or left direction, second area R2 can be wider than first area R1 in this direction.

Since second area R2 is included in display area 141 corresponding to the field of view of reflector 140, what is to be displayed in second area R2 can be included in display area 141.

In each of the first state and the second state, first area R1 displays speedometer G11, which allows the driver to grasp the speed in each of the first state and the second state.

In the second state, second area R2 displays frame image G15 and rear image G16, which allows the driver to grasp frame image G15 and rear image G16.

The switch from the first state to the second state can be made upon satisfaction of the predetermined conditions. The switch to the second state, in which objects are more visible to the driver, improves the visibility. The switch from the first state to the second state can notify the driver of the satisfaction of the predetermined conditions.

The switch from the first state to the second state can be made by sliding first virtual display image 101, which allows the driver to grasp that the switching is in the middle, by viewing the slide display and can maintain the visibility of the speedometer.

The distance between first virtual display image 101 and second virtual display image 201 is within 0.25 diopter in side view of vehicle 1. This can reduce the amount of focus (i.e., the amount of adjusting the focus of eyes), when the driver moves the eyes from first virtual display image 101 to second virtual display image 201.

### Variation 1

Variation 1 will be described. In the following description, the same reference signs as in the embodiment described above and other variations represent substantially the same parts, and the description thereof may be omitted.

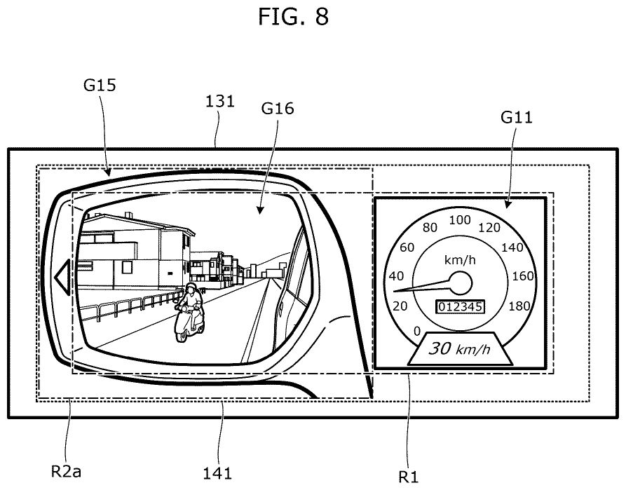

FIG. 8 is an illustration of an example display in the second state shown in Variation 1 of Embodiment 1. As shown in FIG. 8, second area R2a is larger than second area R2 shown in FIG. 6 in the vertical direction. Specifically, second area R2a is in a size equal to the size of display area 141 corresponding to the field of view of reflector 140 in the vertical direction. In this manner, the size of second area R2a is equal to the size of display area 141 in the vertical direction. What is to be displayed in the second state can thus be included in display area 141 and can be made as large as possible. Note that second area R2a may be in a size equal to the size of display area 141 in the horizontal direction.

### Variation 2

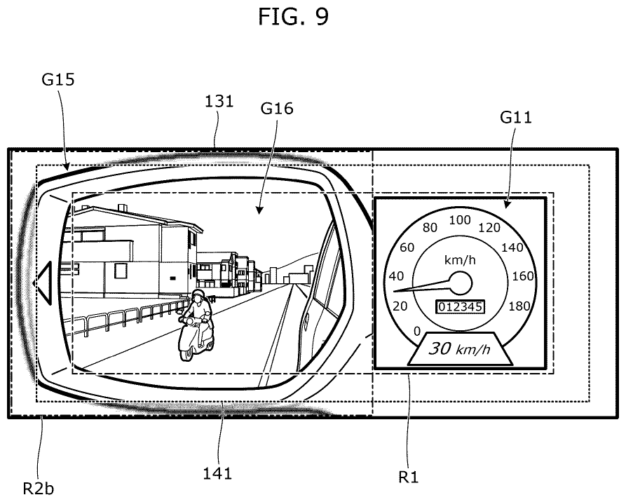

Variation 2 will be described. FIG. 9 is an illustration of an example display in the second state shown in Variation 2 of Embodiment 1. As shown in FIG. 9, second area R2b is larger than second area R2a shown in FIG. 8 in the vertical direction and in the horizontal direction. Specifically, second area R2b is in a size over display area 141 corresponding to the field of view of reflector 140 in the vertical direction and in the horizontal direction. In FIG. 9, the part extending beyond display area 141 is blurred. This part beyond display area 141 is invisible to the driver's point of view in eye box I. When the driver changes the posture and the driver's point of view moves out of eye box I, the part may become visible.

In this manner, second area R2b is in a size over display area 141 in at least one of the vertical direction or the horizontal direction. What is to be displayed in the second state can thus be displayed in an enlarged manner in display area 141.

### Variation 3

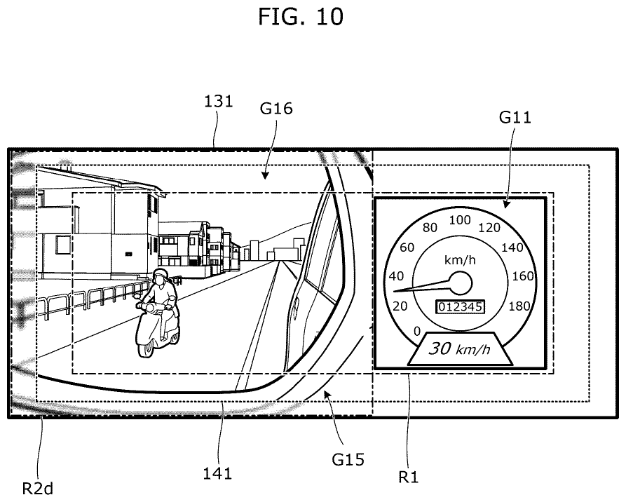

Variation 3 will be described. FIG. 10 is an illustration of an example display in the second state shown in Variation 3 of Embodiment 1. In the example display shown in FIG. 10, second area R2d displays frame image G15 and rear image G16 in a more enlarged manner than in the example display shown in FIG. 9. In this case, rear image G16 occupies most of second area R2d, which allows the driver to grasp the details of rear image G16 more easily.

### Variation 4

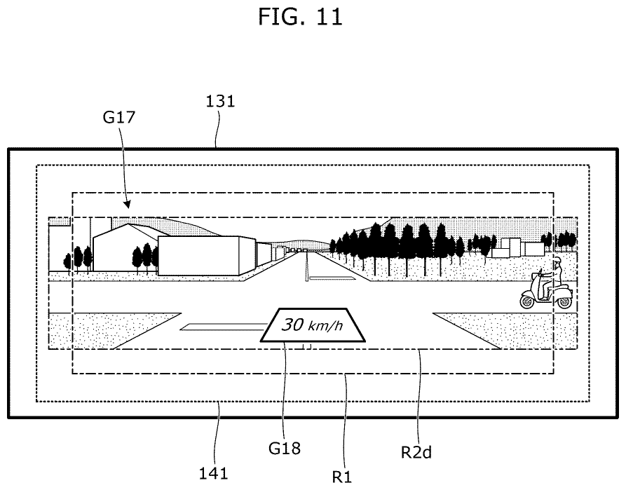

Variation 4 will be described. FIG. 11 is an illustration of an example display in the second state shown in Variation 4 of Embodiment 1. As shown in FIG. 11, second area R2d has the right and left ends beyond first area R1 but is smaller than first area R1 in the vertical direction. In Variation 4, controller 500 causes first display device 100 to display front image G17 and speedometer G18 in second area R2d. In this manner, in the second state, second area R2d, which is larger than first area R1 in the horizontal direction, displays front image G17. This allows the driver to grasp the target of attention (e.g., a motorcycle), which is less visible to the driver directly, for example, at an intersection with poor visibility.

### Variation 5

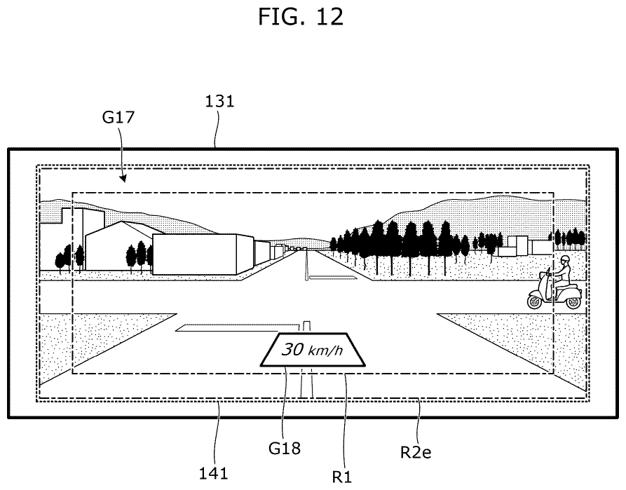

Variation 5 will be described. FIG. 12 is an illustration of an example display in the second state shown in Variation 5 of Embodiment 1. As shown in FIG. 12, second area R2e is in a size larger than the size of first area R1 in the vertical direction and in the horizontal direction. That is, since second area R2e is larger than second area R2d shown in FIG. 11, front image G17 can be displayed more largely in this second area R2e.

### Variation 6

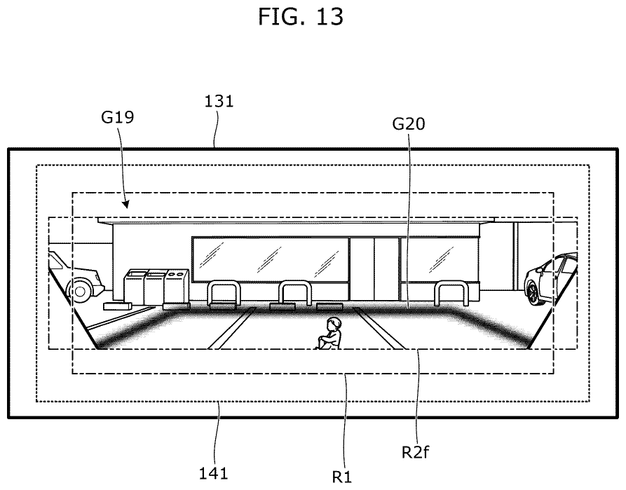

Variation 6 will be described. FIG. 13 is an illustration of an example display in the second state shown in Variation 6 of Embodiment 1. As shown in FIG. 13, second area R2f has right and left ends beyond first area R1 but is smaller than first area R1 in the vertical direction. In Variation 6, controller 500 causes first display device 100 to display front image G19 and hood frame image G20 showing the hood in an overlapping manner. Hood frame image G20 is displayed in an emphasized manner (e.g., brightened or blurred to display the image within the hood frame in a relatively emphasized manner). In this case, the target of attention, which is blocked by the hood for the driver, is displayed as front image G19, which allows the driver to grasp the target of attention.

### Variation 7

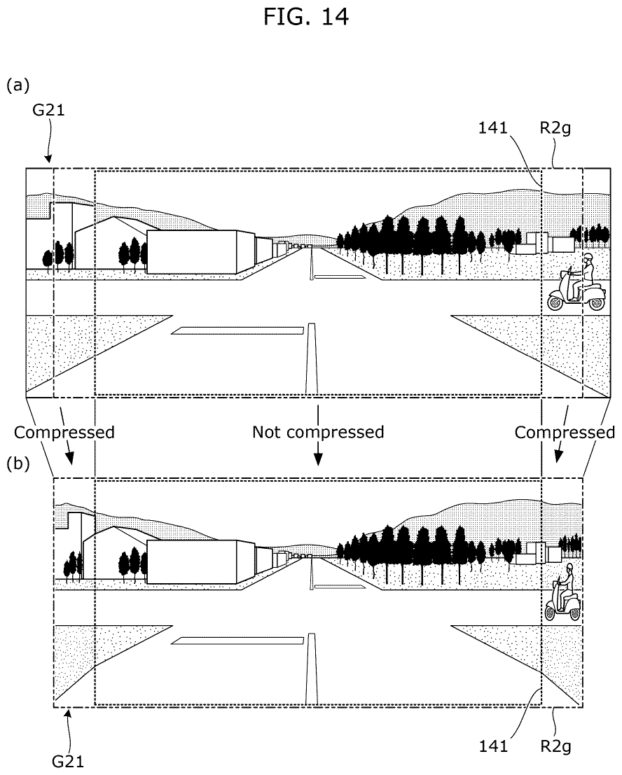

Variation 7 will be described. FIG. 14 is an illustration of an example display in the second state shown in Variation 7 of Embodiment 1. In FIG. 14, (a) shows that captured front image G21 is, as it is, larger than second area R2g in the horizontal direction. In this case, controller 500 causes second area R2g to include front image G21 as shown in (b) of FIG. 14, after compressing only the parts (i.e., the right and left ends) of front image G21 extend beyond display area 141 corresponding to the field of view of reflector 140 in the horizontal direction. The compression in the horizontal direction has been described as an example, the same applies to the vertical direction.

### Variation 8

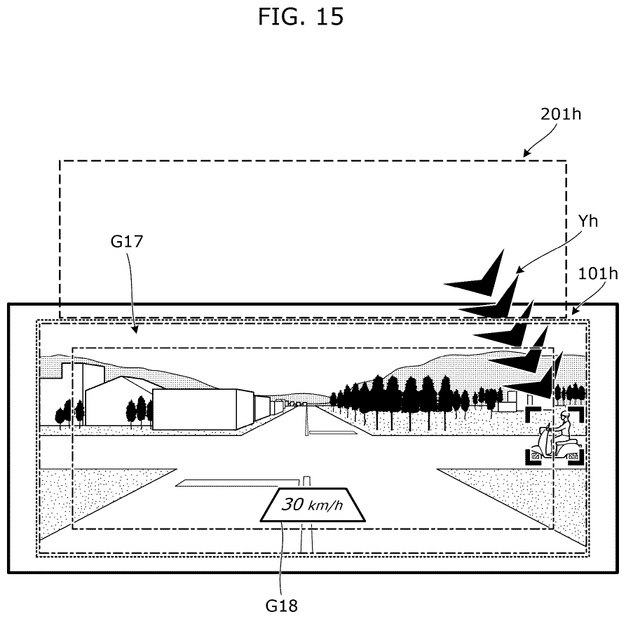

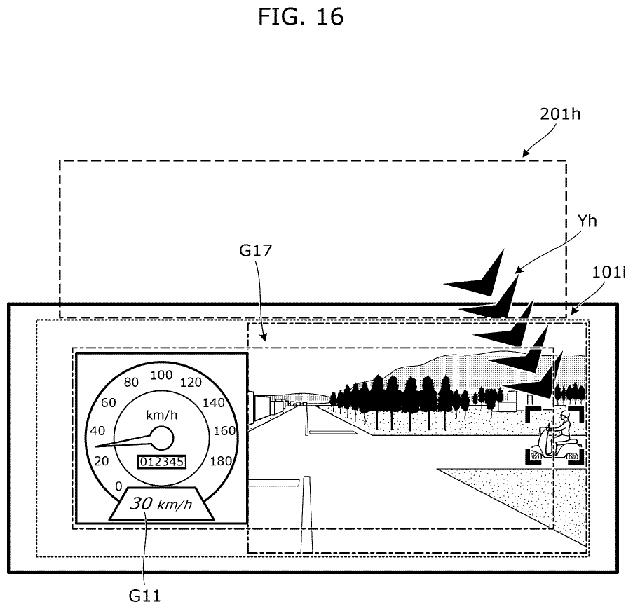

Variation 8 will be described. FIG. 15 is an illustration of an example display in the second state shown in Variation 8 of Embodiment 1. In FIG. 15, first virtual display image 101h and second virtual display image 201h are aligned. Controller 500 causes first display device 100 and second display device 200 to display arrow Yh across first virtual display image 101h and second virtual display image 201h. Arrow Yh indicates the target of attention. When the driver views this arrow Yh, the eyes are guided to recognize the target of attention (e.g., the motorcycle) included in front image G17. In this manner, arrow Yh is displayed across first virtual display image 101h and second virtual display image 201h. This can guide the eyes from first virtual display image 101h to second virtual display image 201h, by causing the driver to view arrow Yh. Note that FIG. 16 is an illustration of another example display in the second state shown in Variation 8. As shown in this FIG. 16, speedometer G11 may be displayed in first virtual display image 101i.

### Variation 9

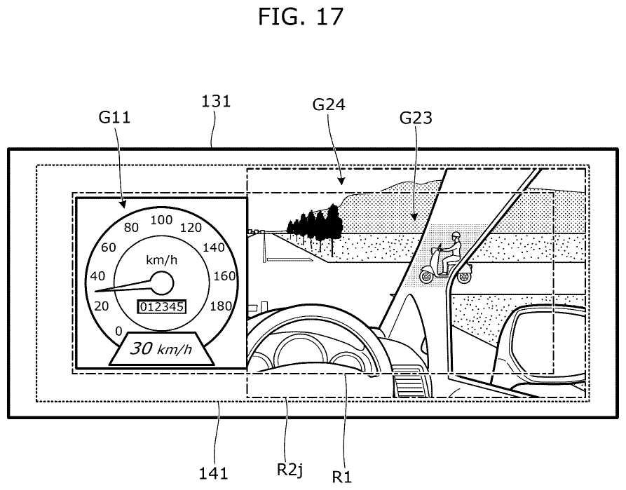

Variation 9 will be described. FIG. 17 is an illustration of an example display in the second state shown in Variation 9 according to Embodiment 1. As shown in FIG. 17, second area R2j extends beyond first area R1 in the vertical direction and to the right. In Variation 7, controller 500 causes first display device 100 to display, in second area R2j, pillar image G23 showing a pillar of vehicle 1 after overlapping surrounding image G24 captured by a camera outside the pillar. Pillar image G23 may be made translucent to display the target of attention overlapping the pillar to be visible to the driver. In this manner, in the second state, pillar image G23 and surrounding image G24 are displayed in second area R2j in an overlapping manner, which allows the driver to grasp pillar image G23 and surrounding image G24.

### Variation 10

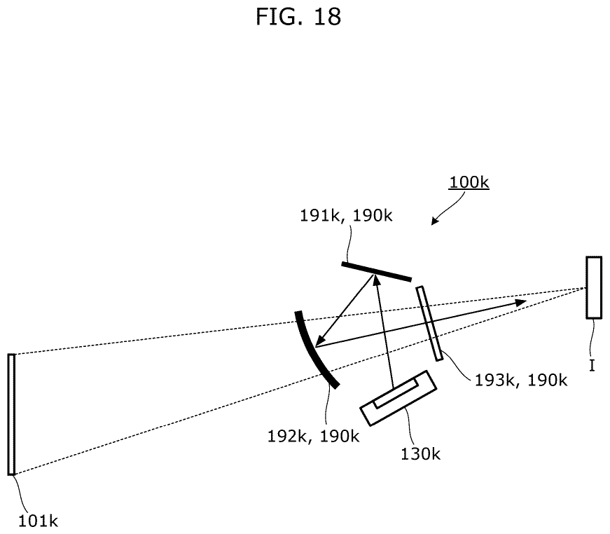

Variation 10 will be described. FIG. 18 is a schematic view showing a schematic configuration of first display device 100k according to Variation 10 of Embodiment 1. As shown in FIG. 18, first display device 100k includes display element 130k and optical system 190k. Display element 130k is oriented to project video light upward. Optical system 190k includes first reflector 191k, second reflector 192k, and translucent cover 193k, and guides the video light from display element 130k to the eyes (i.e., eye box I) of the driver. First reflector 191k is a plane mirror above display element 130k, and reflects the video light from display element 130k toward second reflector 192k. Second reflector 192k is a concave mirror in front of display element 130k and first reflector 191k, and reflects the video light reflected by first reflector 191k toward the driver. Translucent cover 193k is a cover body located behind second reflector 192k and made of glass. The video light reflected by second reflector 192k is transmitted through translucent cover 193, heads for the eyes of the driver, and serves as first virtual display image 101k. Such the configuration provides a long optical path, which can create first virtual display image 101k at a far point of view.

### Variation 11

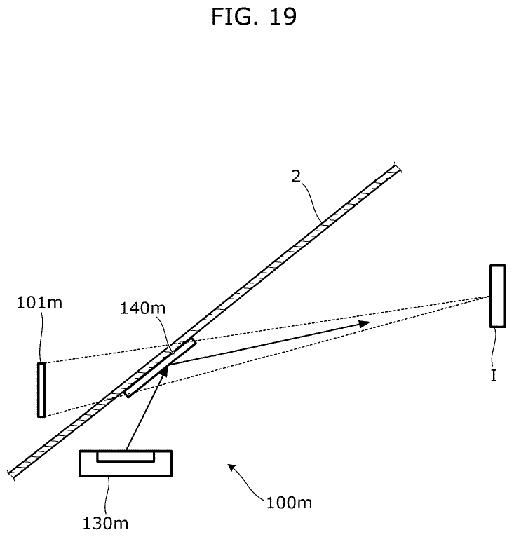

Variation 11 will be described. FIG. 19 is a schematic view showing a schematic configuration of first display device 100m according to Variation 11 of Embodiment 1. As shown in FIG. 19, first display device 100m includes display element 130m and reflector 140m.

Display element 130m is oriented to project video light toward windshield 2. Reflector 140m is a mirror on windshield 2 in an area to project video light. Reflector 140m reflects the video light emitted from display element 130m toward the driver. That is, the video light reflected by reflector 140m heads for the eyes (i.e., eye box I) of the driver on the driver's seat, and serves as first virtual display image 101m. In this manner, reflector 140m is provided on windshield 2, which can reduce the space consumption by reflector 140m and downsize the system as a whole.

### Variation 12

Variation 12 will be described. FIG. 20 is a schematic view showing display system 10n according to Variation 12 of Embodiment 1. As shown in FIG. 20, display system 10n includes camera 400n for capturing an image of the head of the user. Camera 400n is located near the top of windshield 2. Camera 400n is located with the viewing angle oriented to the rear of the vehicle compartment. Camera 400n is connected communicably to controller 500, and outputs the captured video to controller 500. Controller 500 performs known imaging processing on the video obtained from camera 400n and extracts the point of view from a plurality of feature points included in the head of the user. In addition, controller 500 detects the point of view by comparing the feature points of the vehicle compartment in the video to the point of view. That is, camera 400n and controller 500 is an example of the viewpoint detector according to the present disclosure.

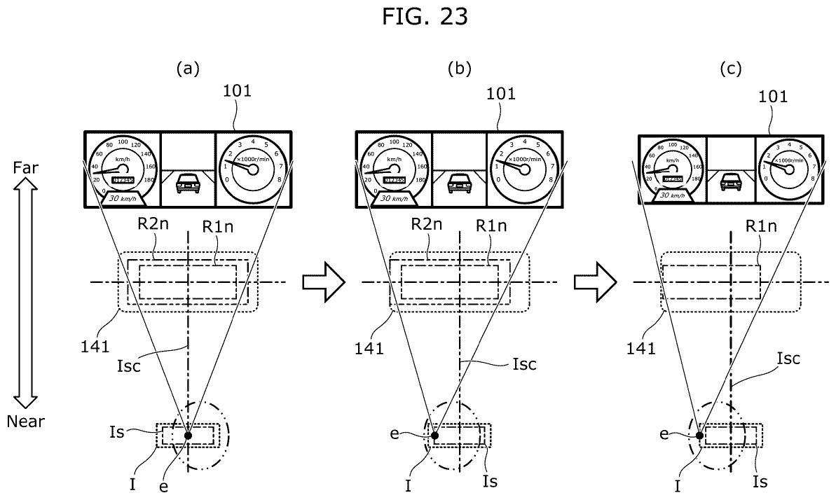

Controller 500 determines whether the detected point of view is within predetermined area Is (see, e.g., FIG. 23). Here, predetermined area Is is smaller than eye box I. For example, predetermined area Is has a length of 100 mm in the horizontal direction and a length of 20 mm in the vertical direction, where eye box I has a length of 130 mm in the horizontal direction and a length of 40 mm in the vertical direction. When determining that the detected point of view is within predetermined area Is, controller 500 causes first display device 100 to display first virtual display image 101 in the second state. On the other hand, when determining that the detected point of view is out of predetermined area Is, controller 500 causes first display device 100 to display first virtual display image 101 in the first state.

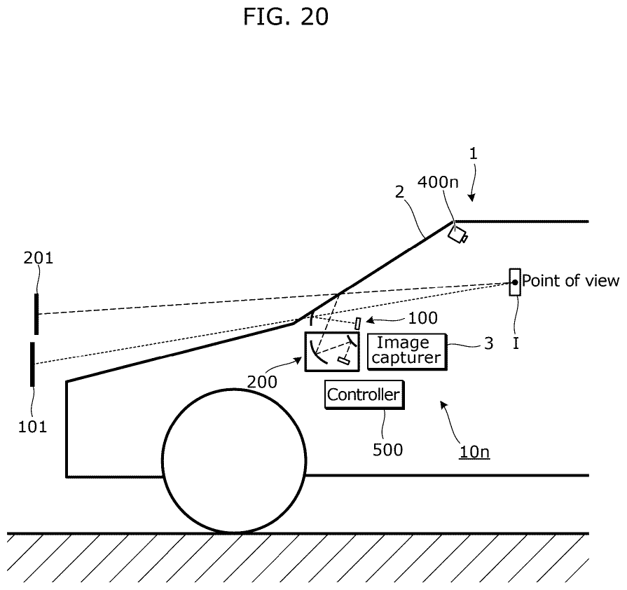

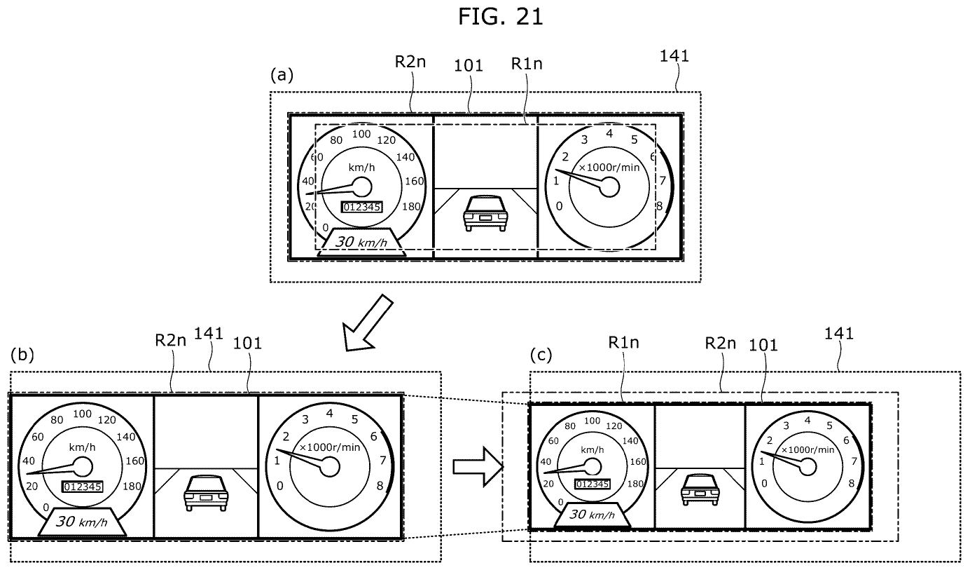

FIG. 21 is an illustration of an example display according to Variation 12. In FIG. 21, second area R2n is in a size larger than first area R1n in the vertical direction and in the horizontal direction. In FIG. 21, (a) is an example display where the point of view is within predetermined area Is. Accordingly, since controller 500 determines that the detected point of view is within predetermined area Is, first display device 100 displays first virtual display image 101 in the second state. That is, first virtual display image 101 is displayed in whole second area R2n.

In FIG. 21, (b) shows an example display immediately before the point of view moves to the left and comes out of predetermined area Is. At this time, second area R2n is seen at the left of display area 141 in accordance with the movement of the point of view but is within display area 141. First virtual display image 101 in second area R2n is thus visible to the user. That is, first virtual display image 101 is displayed in the second state.

In FIG. 21, (c) shows an example display where the point of view has further moved to the left and is beyond predetermined area Is. In this case, second area R2n also extends beyond display area 141. Thus, if the second state continues, the left end of first virtual display image 101 is seen for the user as lacking. Accordingly, when determining that the detected point of view is out of predetermined area Is, controller 500 displays first virtual display image 101 in the first state, by displaying the video to be displayed by first display device 100 in a reduced size. That is, first virtual display image 101 is displayed in whole first area R1n, that is, smaller than in the second state. At the switch from the second state to the first state, first virtual display image 101 may shift immediately or gradually.

Here, the switch from the second state to the first state includes a first switching mode and a second switching mode. While the first switching mode and the second switching mode will be described where the point of view of the user moves to the left, in principle, the same applies to the cases where the point of view moves in the other directions (e.g., to the right, upward, and downward).

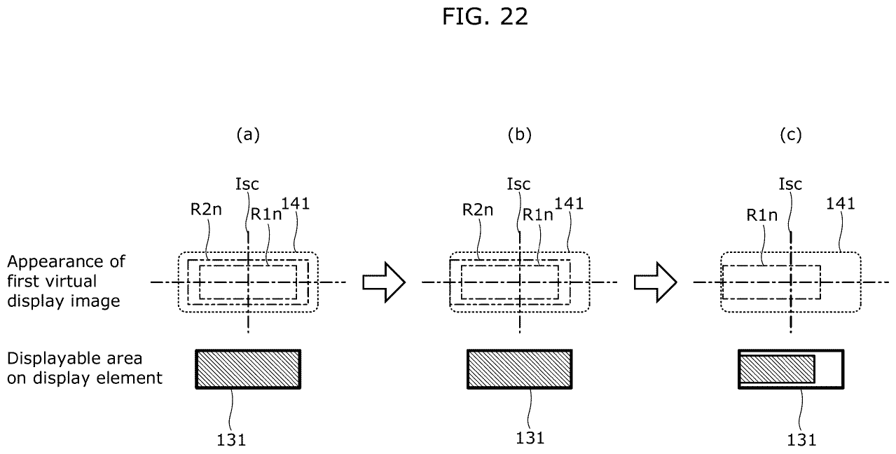

First, the first switching mode will be described. In the first switching mode, the center of first virtual display image 101 in the horizontal direction seems displaced from the center of display area 141 in the horizontal direction in accordance with the movement of point of view e. FIG. 22 is an illustration of appearance of first virtual display image 101 in the first switching mode according to Embodiment 1, and a change from the display area on display element 130. FIG. 23 is an illustration including a change in point of view e of the user in the first switching mode according to Embodiment 1. FIG. 23 illustrates point of view e using the left eye of the user as an example. Display area 141 corresponding to the field of view of reflector 140 is located beyond point of view e (i.e., above point of view e in FIG. 23), and first virtual display image 101 is beyond display area 141. Note that FIG. 23 shows no display element 130.

An example will be described in (a) of FIG. 22 and (a) of FIG. 23 where point of view e is located at center Isc of predetermined area Is in the horizontal direction. In this case, whole display area 131 of display element 130 is a displayable area (i.e., the hatched area in (a) of FIG. 22). At this time, the centers of first area R1n and second area R2n in the horizontal direction almost match center Isc. Second area R2n displays first virtual display image 101.

In each of FIGS. 22 and 23, (b) shows a state immediately before point of view e moves to the left and comes out of predetermined area Is. In this case, as well, whole display area 131 of display element 130 is a displayable area (i.e., the hatched area in (b) of FIG. 22). At this time, the centers of first area R1n and second area R2n in the horizontal direction are displaced from center Isc in accordance with the movement of point of view e. This displaced second area R2n displays first virtual display image 101.

In each of FIGS. 22 and 23, (c) shows that point of view e further moves to the left and comes out of predetermined area Is. At this time, the display is switched to the first state. In the first state, since controller 500 causes first virtual display image 101 to be displayed only in first area R1n, a part of whole display area 131 of display element 130 is a displayable area (i.e., the hatched area in (c) of FIG. 22). At this time, the center of first area R1n in the horizontal direction is further displaced from center Isc further to the left in accordance with the movement of point of view e. This displaced first area R1n displays first virtual display image 101, which causes the user to view first virtual display image 101 in a smaller size.

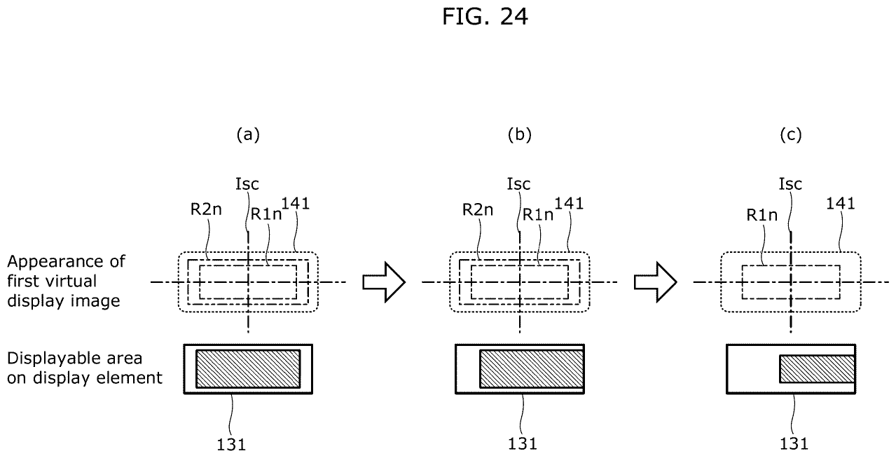

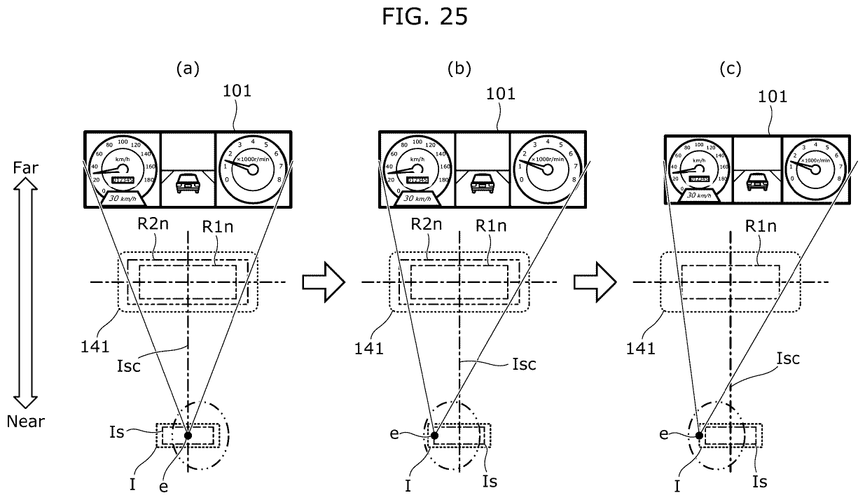

Now, the second switching mode will be described. In the second switching mode, even when point of view e moves, the center of first virtual display image 101 in the horizontal direction is unchanged. FIG. 24 is an illustration of appearance of first virtual display image 101 in the second switching mode according to Embodiment 1, and a change from the display area on display element 130. FIG. 25 is an illustration including a change in point of view e of the user in the second switching mode according to Embodiment 1. FIG. 24 corresponds to FIG. 22, and FIG. 25 corresponds to FIG. 23.

In each of FIGS. 24 and 25, (a) shows a case where point of view e is located at center Isc of predetermined area Is in the horizontal direction. In this case, the displayable area (i.e., the hatched area in (a) of FIG. 24) is smaller than whole display area 131 of display element 130 in the horizontal and vertical directions. At this time, the centers of first area R1n and second area R2n in the horizontal direction almost match center Isc. Second area R2n displays first virtual display image 101.

In each of FIGS. 24 and 25, (b) shows a state immediately before point of view e moves to the left and comes out of predetermined area Is. At this time, the displayable area (i.e., the hatched area in (b) of FIG. 24) of display element 130 moves in the opposite direction, that is, to the right in conjunction with the movement of point of view e. Accordingly, the centers of first area R1n and second area R2n in the horizontal direction remain almost matching center Isc. Second area R2n displays first virtual display image 101.

In each of FIGS. 24 and 25, (c) shows point of view e further moves to the left and comes out of predetermined area Is. At this time, the display is switched to the first state. In the first state, only first area R1n, which is smaller than second area R2n, displays first virtual display image 101. That is, the displayable area (i.e., the hatched area in (c) of FIG. 24) of display element 130 becomes smaller.

As described above, the display is performed in the second state, when point of view e is within predetermined area Is; and in the first state, when point of view e is out of predetermined area Is. That is, the display is switchable between the first state and the second state in accordance with the location of point of view e.

### Variation 13

Variation 13 will be described. An example will be described in Variation 13 where second area R2m displays guide marks M1 for guiding the eyes of the user toward the target of attention included in rear image G16. This display is executed by controller 500 controlling first display device 100.

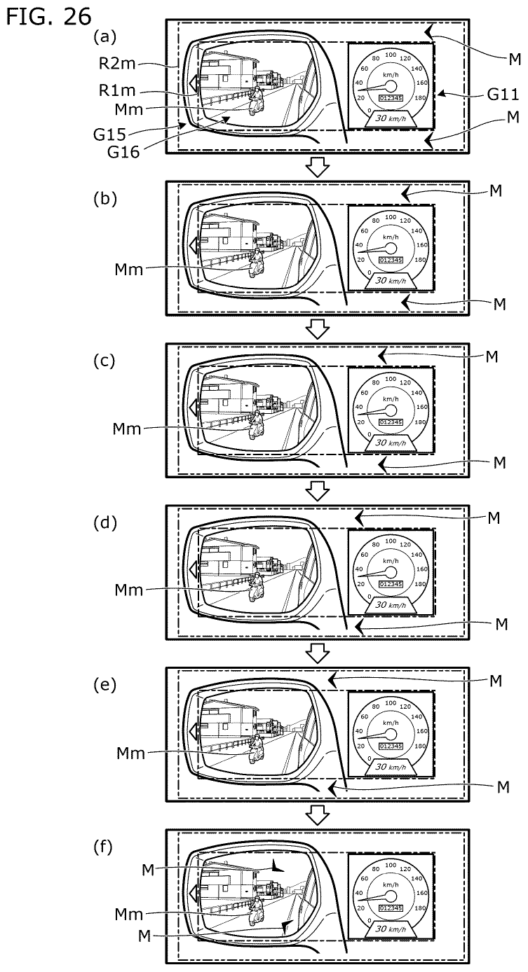

FIG. 26 is an illustration of an example display according to Variation 13 of Embodiment 1. In FIG. 26, second area R2m is in a size larger than the size of first area R1m in the vertical direction and in the horizontal direction. First area R1m displays speedometer G11, and second area R2m displays frame image G15.

In rear image G16 in frame image G15, a motorcycle is displayed as target Mm of attention. Controller 500 causes first display device 100 to display, in second area R2m, guide marks M for guiding the eyes of the user toward target Mm of attention in frame image G15. While an example has been described here where guide mars M are provided on the top and bottom, guide mark M may be provided only on the top or bottom. However, guide mars M are provided on the top and bottom in one preferred embodiment, because one of them may become less visible depending on the sitting height of the user.

As shown in (a) of FIG. 26, guide marks M are displayed to gradually approach target Mm of attention in the order of (b), (c), (d), (e), and (f) after being displayed at the initial positions. This display may be repeated. That is, after coming close to target Mm of attention, guide marks M return to the initial positions and are displayed to approach target Mm of attention again.

Controller 500 may cause guide marks M to be displayed in a more emphasized manner with a decreasing distance between vehicle 1 and the actual target of attention. Examples of this emphasis include an increase in the moving speed of guide marks M, an increase in the size of guide marks M, and a change in the color of guide marks M.

As described above, second area R2m displays guide marks M toward target Mm of attention included in rear image G16. The user can move the eyes to target Mm of attention by viewing guide marks M. Accordingly, the user can notice target Mm of attention earlier.

Being displayed to gradually approach target Mm of attention, guide marks M can be expressed like an animation, which allows the user to notice guide marks M more easily. In addition, guide marks M are displayed in the more emphasized manner with the decreasing distance between vehicle 1 and the actual target of attention, which can notify the user of the fact that the distance to the actual target of attention is decreasing.

After coming close to target Mm of attention, guide marks M return to the initial positions and are displayed to approach target Mm of attention again. That is, guide marks M repeat the approach to target Mm of attention, which allows the user to notice guide marks M more easily.

### Embodiment 2

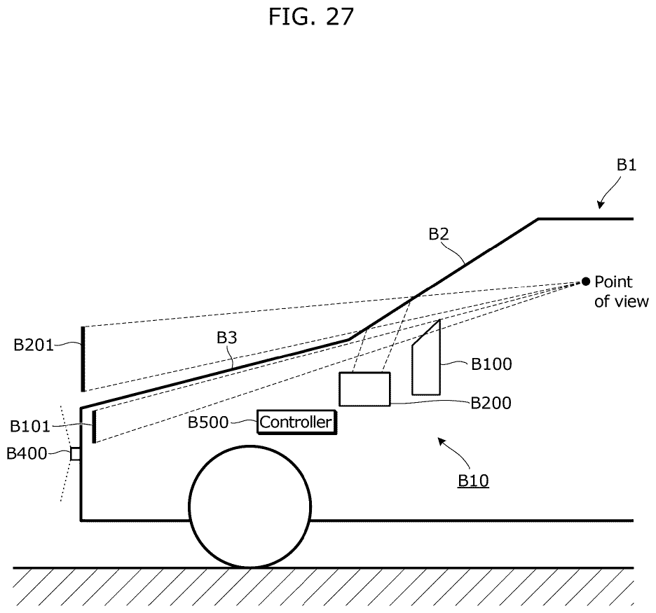

FIG. 27 is a schematic view showing that display system B10 according to Embodiment 2 is placed on vehicle B1. FIG. 27 shows vehicle B1 in a cross section. Here, the user of display system B10 is the user in a vehicle B1.

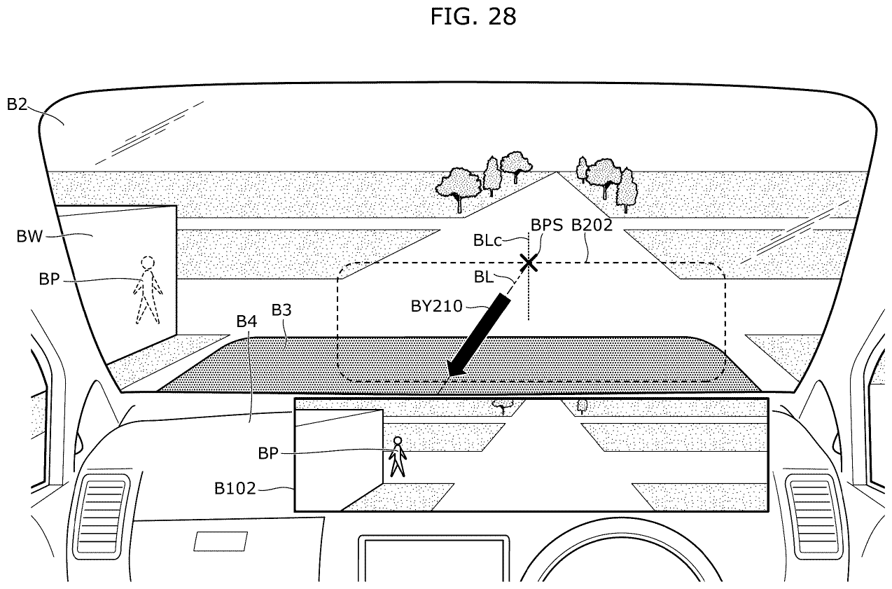

As shown in FIG. 27, display system B10 includes first display device B100, second display device B200, image capturer B400, and controller B500. First display device B100 and second display device B200 are located in dashboard B4 (see FIG. 28) of vehicle B1, for example. First display device B100 and second display device B200 display, for example, the vehicle information on vehicle B1 as first virtual image B101 and second virtual image B201. Examples of the vehicle information include the vehicle speed of vehicle B1, the RPM of the engine, results of detecting objects approaching vehicle B1, navigation information from the current location to the destination of vehicle B1, image information obtained by a camera for capturing an image of the rear of vehicle B1, and notification information for notifying the driver. The notification information indicates that target BP (see FIG. 28) in an image captured by image capturer B400, and is an example of the target of attention whose presence the driver needs to be warned of. For example, target BP is a moving body (e.g., a vehicle (an automobile, a motorcycle, or a scooter) other than a pedestrian, an animal, or a vehicle other than vehicle B1) around vehicle B1. That is, the notification information is for notifying the driver of vehicle B1 of the fact that a moving body is approaching vehicle B1.

While an example has been illustrated in FIG. 27 where first display device B100 and second display device B200 are located in dashboard B4, the locations of first display device B100 and second display device B200 are not limited thereto. For example, first display device B100 may be located at the center console, or second display device B200 may be located near the upper end of windshield B2.

First display device B100 is an opaque display. First display device B100 projects video light toward the driver. The driver grasps the video light, which has entered the eyes, as first virtual image B101 projected far away from first display device B100. That is, the video light projected from first display device B100 heads for the eyes of the driver on the driver's seat and serves as first virtual image B101. First virtual image B101 is an example of the first virtual display image. FIG. 27 shows an example location of first virtual image B101 seen from the driver's point of view. Note that first display device B100 may be a transmissive display, such as a head-up display (HUD). FIG. 27 shows an example location of first virtual image B101 seen from the driver's point of view. This location can be set by adjusting the viewing distance of the video light projected from first display device B100. The driver's point of view is a reference point of eyes, for example. The reference point of eyes is a point representing the position of the eyes of the driver in normal driving.

Second display device B200 is a transmissive display, such as an AR-HUD. Second display device B200 projects light to windshield B2 that is a display medium. The projected light is reflected by windshield B2. This reflected light heads for the eyes of the driver on the driver's seat. The driver grasps the reflected light, which has entered the eyes, as second virtual display image B201 seen on the opposite side of windshield B2 (i.e., outside the vehicle) with a real object seen through windshield B2 in the background. Second virtual image B201 is an example of the second virtual display image.

Image capturer B400 is a camera for capturing an image of the surroundings of vehicle B1. Specifically, image capturer B400 captures an image of the front of vehicle B1. Image capturer B400 is located in front of the driver on the driver's seat. Specifically, image capturer B400 is located at the head of vehicle B1. Accordingly, image capturer B400 can capture target BP in a blind spot seen for the driver.

Controller B500 is located in dashboard B4, and controls first display device B100, second display device B200, and image capturer B400. Specifically, controller B500 includes a CPU, a RAM, and a ROM, for example, and executes various processing by the CPU developing and executing, in the RAM, the programs in the ROM. For example, controller B500 performs imaging processing on the image data obtained by image capturer B400, recognizes at least one target BP in the image data, and detects the location coordinate, size, or any other suitable parameter of target BP. In addition, controller B500 performs imaging processing on the image data, recognizes a structure (e.g., a building or a wall) included in the image data, and detects the location coordinate, size, or any other suitable parameter of the structure. Controller B500 extracts target BP in a blind spot behind a structure from the driver's point of view (i.e., the reference point of eyes), prepare first guide information BY210 (see FIG. 28) based on the location coordinate, size, or any other suitable parameter of extracted target BP, and causes second display device B200 to display first guide information BY210.

### How to Guide Eyes

Now, guiding of the eyes of the driver using first virtual image B101 and second virtual image B201 will be described. In the guiding of the eyes, the display is switched from a first eye guiding display to a second eye guiding display.

First, the first eye guiding display will be described. FIG. 28 is an illustration of an example first eye guiding display according to Embodiment 2. In FIG. 28, almost the lower half of second display area B202 of second virtual image B201 displayed by second display device B200 overlaps hood B3 of vehicle B1, while second display area B202 overlapping windshield B2 as a whole. First display area B102 of first virtual image B101 displayed by first display device B100 overlaps dashboard B4.

In the first eye guiding display, controller B500 causes second display device B200 to display first guide information BY210 as an arrow in second display area B202 of second virtual image B201. On the other hand, controller B500 causes first display device B100 to display a video captured by image capturer B400 in whole first display area B102 of first virtual image B101. Here, the video captured by image capturer B400 is an example of the vehicle surrounding information. The vehicle surrounding information indicates the state of the surroundings of vehicle B1, and corresponds to the video in front of vehicle B1 captured by image capturer B400 in this embodiment. Note that the vehicle surrounding information may be a navigation image in conjunction with a video captured by image capturer B400 or may be a combination of a video and a navigation image.

First guide information BY210 is an arrow for guiding the eyes of the driver to first display area B102 of first virtual image B101. While an example has been described in this embodiment where the arrow represents first guide information BY210, any other figure may be used as long as capable of guiding the eyes of the driver to first display area B102.

Target BP is in a blind spot of wall BW and invisible to the driver's point of view, but captured by image capturer B400 and thus included in the video captured by image capturer B400. Controller B500 extracts this target BP in the blind spot, and locates first guide information BY210 on straight line BL connecting the coordinate position and display reference point BPS. Straight line BL is an imaginary straight line set across first display area B102 and second display area B202, and is displayed neither in first display area B102 nor in second display area B202, but may be displayed therein.

An example is described in this embodiment where target BP is outside second display area B202. Display reference point BPS is thus set on center line BLc of second display area B202 in the transverse direction (i.e., the vehicle transverse direction). Display reference point BPS may be located inside or outside second display area B202. In addition, display reference point BPS may be located at a vanishing point as seen from the driver. In this case, the driver notices first guide information BY210 more easily when viewing the front.

After that, when target BP appears from the back of the structure and comes out of the blind spot as seen from the driver's point of view, controller B500 causes first display device B100 and second display device B200 to switch the display of first virtual image B101 and second virtual image B201 from the first eye guiding display to the second eye guiding display.

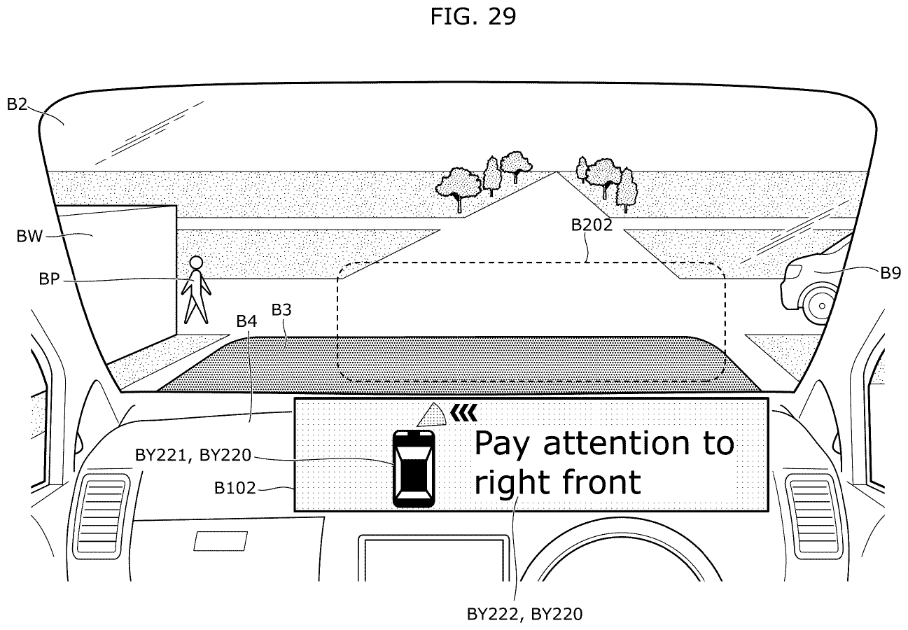

FIG. 29 is an illustration of an example second eye guiding display according to Embodiment 2. Specifically, as shown in FIG. 29, controller B500 causes second display device B200 to stop displaying second virtual image B201. At the same time, controller B500 causes first display device B100 not to display the vehicle surrounding information (i.e., the video captured by image capturer B400) in first display area B102 of first virtual image B101, and to display second guide information BY220 in first display area B102. Second guide information BY220 is for encouraging the guiding of the eyes of the driver to the front of vehicle B1. Second guide information BY220 shown in FIG. 29 includes icon information BY221 and text information BY222 for encouraging the guiding of eyes to the right front of vehicle B1. Icon information BY221 includes a vehicle figure showing vehicle B1 and a figure indicating the direction of guiding the eyes to the vehicle figure. Text information BY222 includes character information meaning the direction of guiding the eyes of the driver and the motive. In this embodiment, there is another vehicle B9, which is a target of attention, at the right front of vehicle B1. Controller B500 thus extracts other vehicle B9 based on the vehicle surrounding information obtained by image capturer B400, and recognizes the direction of other vehicle B9 with respect to vehicle B1 from the coordinate position. Based on the recognized direction, controller B500 determines the direction of guiding the eyes of the driver, and prepares second guide information BY220 based on the direction. After that, controller B500 causes first display device B100 to display second guide information BY220 in first display area B102 of first virtual image B101.

In FIG. 29, there is other vehicle B9, which is the target of attention, at the right front of vehicle B1. If there is no other vehicle B9 and target BP appears from the back of the structure and comes out of the blind spot, controller B500 may prepare second guide information (e.g., “Pay attention to left front”) based on the direction of target BP and causes the second guide information to be displayed in first display area B102 of first virtual image B101 so as to guide the eyes to target BP. This can reduce the uncertainty as to what the driver, who has recognized target BP in first display area B102 in FIG. 28, views next.

### Advantages

As described above, in this embodiment, in the first eye guiding display, first display area B102 of first virtual image B101 displays the vehicle surrounding information. In addition, second display area B202 of second virtual image B201 displays first guide information BY210 for encouraging the guiding of eyes to first virtual image B101. After that, in the second eye guiding display, first display area B102 displays second guide information BY220 for encouraging the guiding of eyes to the front of vehicle B1. In this manner, in the second eye guiding display, second guide information BY220 is displayed in first virtual image B101, which allows the driver to moves the eyes to the front of the vehicle after viewing second guide information BY220. This can reduce continuous viewing of first virtual image B101 and increase the safety in the safety confirmation.

When displaying second guide information BY220, first display area B102 displays no vehicle surrounding information. The driver can concentrate on second guide information BY220.

When target BP in front of vehicle B1 is determined not to be included in the blind spot for the driver, first display area B102 displays no vehicle surrounding information. This can reduce unintended display of the vehicle surrounding information in first display area B102. Accordingly, the driver can concentrate on viewing the front of the vehicle.

### Variation 1

Variation 1 of Embodiment 2 will be described. In the following description, the same reference signs as in Embodiment 2 described above represent substantially the same parts, and the description thereof may be omitted.

FIG. 30 is an illustration of an example second eye guiding display according to Variation 1 of Embodiment 2. In Variation 1, first display area B102 of first virtual image B101 displays second guide information BY220a, and second display area B202 of second virtual image B201 displays third guide information BY230a. Specifically, controller B500 causes first display device B100 not to display the vehicle surrounding information (i.e., the video captured by image capturer B400) in first virtual image B101 but to display second guide information BY220a in first display area B102. Second guide information BY220a illustrated in Variation 1 is a figure including arrows. On the other hand, controller B500 causes second display device B200 to display third guide information BY230a in second display area B202 of second virtual image B201. Third guide information BY230a is for encouraging the guiding of eyes to the front of vehicle B1. In this variation, third guide information BY230a is a figure including arrows and is oriented in the direction of guiding the eyes (i.e., toward other vehicle B9).

In Variation 1, there is another vehicle B9, which is a target of attention, at the right front of vehicle B1. Controller B500 thus extracts other vehicle B9 based on the vehicle surrounding information obtained by image capturer B400, and recognizes the direction of other vehicle B9 with respect to vehicle B1 from the coordinate position. Based on the recognized direction, controller B500 determines the direction of guiding the eyes of the driver, and prepares third guide information BY230a based on the direction. Controller B500 causes then second display device B200 to display third guide information BY230a in second display area B202 of second virtual image B201 so as to guide the eyes of the driver to other vehicle B9 in front of vehicle B1.

In this manner, when first display area B102 displays second guide information BY220a, second display area B202 displays third guide information BY230a for encouraging the guiding of eyes to the front of vehicle B1. Second guide information BY220a and third guide information BY230a can further guide the eyes of the driver to the front of vehicle B1. This can increase the safety in the safety confirmation.

Second display area B202 displays third guide information BY230a so as to guide the eyes onto another vehicle B9 (i.e., the target of attention) in front of vehicle B1. Third guide information BY230a can thus guide the eyes of the driver to other vehicle B9. This can increase the safety in the safety confirmation.

If there is no other vehicle B9, controller B500 may cause the display device to display the second guide information toward target BP in first display area B102, and the third guide information in second display area B202.

### Variation 2

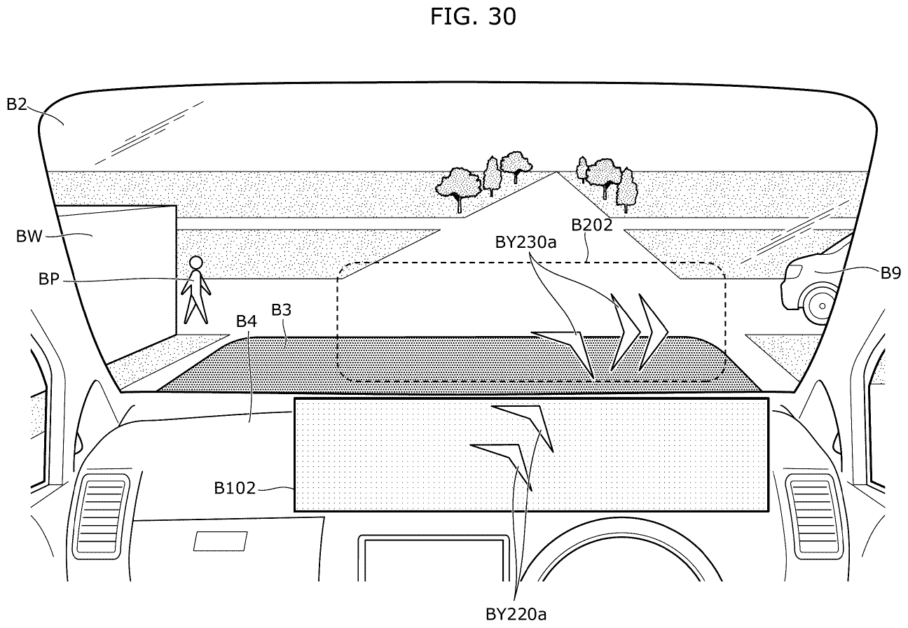

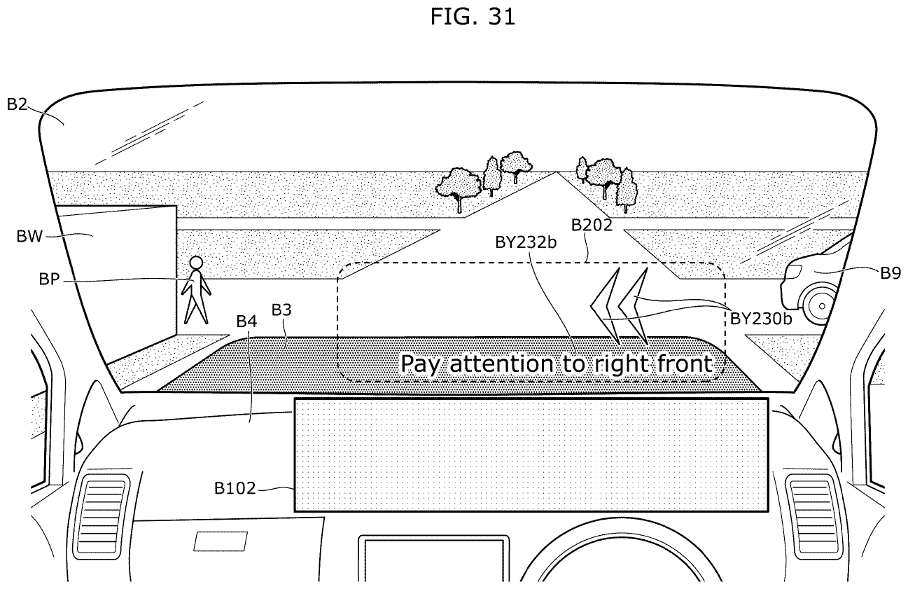

Variation 2 will be described. An example will be described in Variation 2 where a third eye guiding display is newly performed after the second eye guiding display according to Embodiment 2. FIG. 31 is an illustration of an example third eye guiding display according to Variation 2.

At the elapse of a certain period of time after the second eye guiding display, controller B500 causes first display device B100 to bring first display area B102 of first virtual image B101 to a non-display state, and causes second display device B200 to display third guide information BY230b and text information BY232b in second display area B202 of second virtual image B201. In this variation, third guide information BY230b is a figure including arrows and oriented in the moving direction of other vehicle B9. Text information BY232b includes character information meaning the direction of guiding the eyes of the driver and the motive.

In this manner, next information BY232b for assisting the guiding of the eyes is displayed together with third guide information BY230b in second display area B202 of second virtual image B201. The driver can move the eyes to other vehicle B9 more easily, by viewing third guide information BY230b and text information BY232b.

After being displayed for a certain period of time, the vehicle surrounding information is no more displayed in first display area B102 of first virtual image B101. This can reduce the display of the vehicle surrounding information in first display area B102 for a long time. Accordingly, the driver can concentrate on viewing the front of the vehicle.

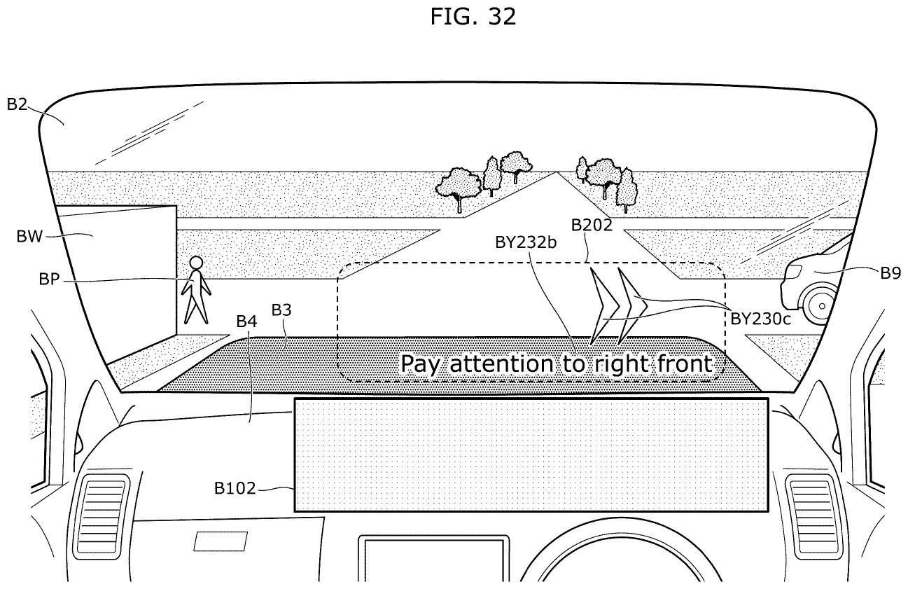

FIG. 32 is an illustration of another example third eye guiding display according to Variation 2 of Embodiment 2. As shown in FIG. 32, third guide information BY230c may be oriented in the direction of guiding the eyes (i.e., toward other vehicle B9).

FIG. 33 is an illustration of another example third eye guiding display according to Variation 2 of Embodiment 2. As shown in FIG. 33, the end of third guide information BY230d in the direction to guide the eyes may be highlight-displayed in second display area B202 of second virtual image B201. The highlight-display is a visually conspicuous display which is emphasized by lighting, flashing, or coloring, for example, to cause the driver to notice the direction. In this manner, the end of second display area B202 is highlight-displayed as third guide information BY230d, which allows the driver to move the eyes to other vehicle B9 by viewing the highlight-display.

In Variation 2 as well as in Variation 1, if there is no other vehicle B9, controller B500 may cause display area B202 to display third guide information to target BP and text information (e.g., “Pay attention to left front”) or may highlight-display the end of second display area B202 in the direction of target BP (i.e., the left in FIG. 33).

### Variation 3

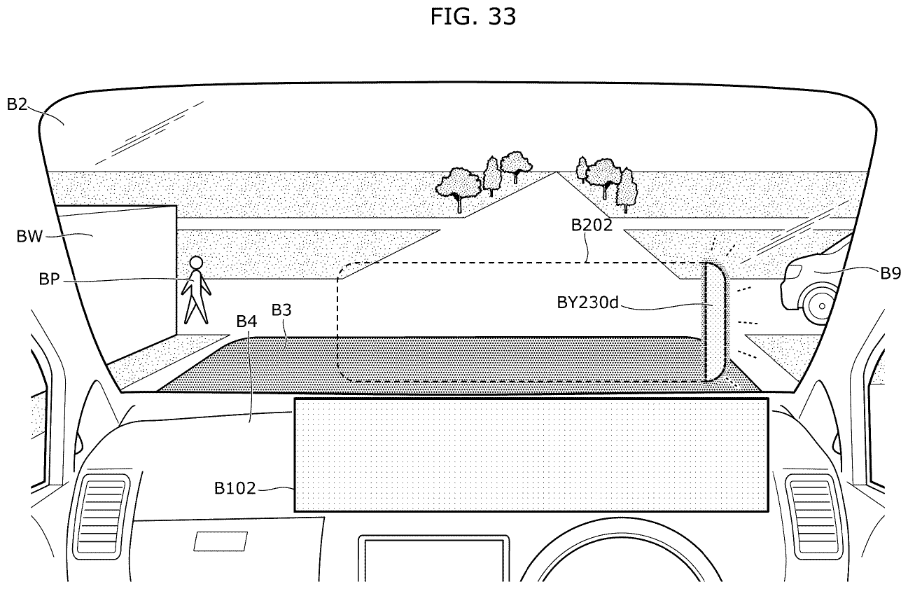

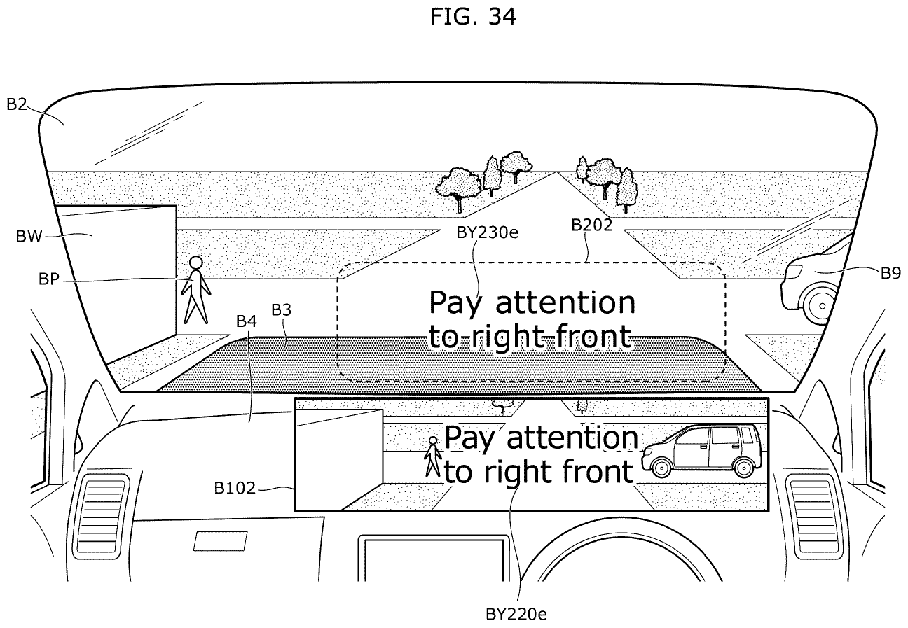

Variation 3 will be described. In Variation 3, another example second eye guiding display will be described. FIG. 34 is an illustration of an example second eye guiding display according to Variation 3 of Embodiment 2. As shown in FIG. 34, in Variation 3, first display area B102 of first virtual image B101 displays second guide information BY220e, and second display area B202 of second virtual image B201 displays third guide information BY230e. Specifically, controller B500 causes first display device B100 to display vehicle surrounding information (i.e., the video captured by image capturer B400) in first display area B102 of first virtual image B101, and second guide information BY220e in first display area B102 after overlapping the vehicle surrounding information. Second guide information BY220e is text information including the character information meaning the direction of guiding the eyes of the driver and the motive.

Controller B500 further causes second display device B200 to display third guide information BY230e in second display area B202 of second virtual image B201. Third guide information BY230e is text information including the character information meaning the direction of guiding the eyes of the driver and the motive.

In this manner, when at least one of second guide information BY220e or third guide information BY230e is displayed, the vehicle surrounding information is also displayed in first display area B102. Accordingly, the driver can move the eyes based on at least one of second guide information BY220e or third guide information BY230e, while checking the vehicle surrounding information.

In Variation 3 as well as in Variation 2, if there is no other vehicle B9, controller B500 may cause at least of first display area B102 or second display area B202 to display text information (e.g., “Pay attention to left front”) informing the driver of target BP.

When the speed of vehicle B1 reaches a certain speed or more, controller B500 causes first display device B100 not to display the vehicle surrounding information in first display area B102. In this case, when the speed of vehicle B1 reaches the certain speed or more, the vehicle surrounding information is not displayed in first display area B102. That is, first display area B102 displays no vehicle surrounding information, when the driver has to concentrate on driving (e.g., at a high speed). That is, the driver can concentrate on viewing the front of the vehicle.

In Embodiment 2 described above, visual guiding of eyes has been described as an example. Alternatively, the guiding of eyes by sound, vibration, or other suitable means may be added.

In Embodiment 2 described above, first display device B100 and second display device B200 for displaying virtual images have been described as an example. Alternatively, at least one of the first display device or the second display device may display non-virtual images.

### Embodiment 3

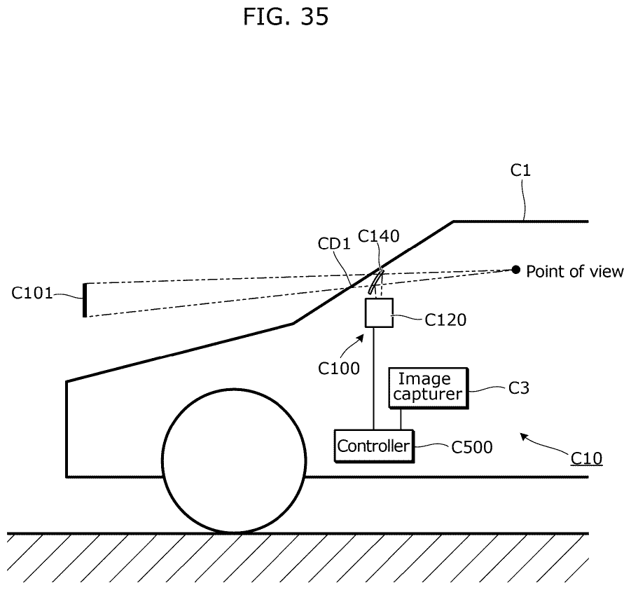

FIG. 35 is a schematic view showing that display system C10 according to Embodiment 3 is placed on vehicle C1. FIG. 35 shows vehicle C1 in a cross section.

As shown in FIG. 35, display system C10 includes display device C100 and controller C500. Display device C100 is located in a dashboard of vehicle C1, for example. Display device C100 displays, for example, the vehicle information on vehicle C1 as virtual display image C101. That is, display device C100 is an example of the first display device, and virtual display image C101 is an example of the first virtual display image. Examples of the vehicle information include the vehicle speed of vehicle C1, the RPM of the engine, results of detecting objects approaching vehicle C1, navigation information from the current location to the destination of vehicle C1, and image information captured by image capturer C3 for capturing an image of the surroundings of vehicle C1. While an example is illustrated in FIG. 35 where display device C100 is located in the dashboard, the location of display device C100 is not limited thereto and display device C100 may be located at the center console, for example.

### Display Device

As shown in FIG. 35, display device C100 projects video light toward the driver who is the user of display system C10. The driver grasps the video light, which has entered the eyes, as virtual display image C101 projected far away from windshield CD1.

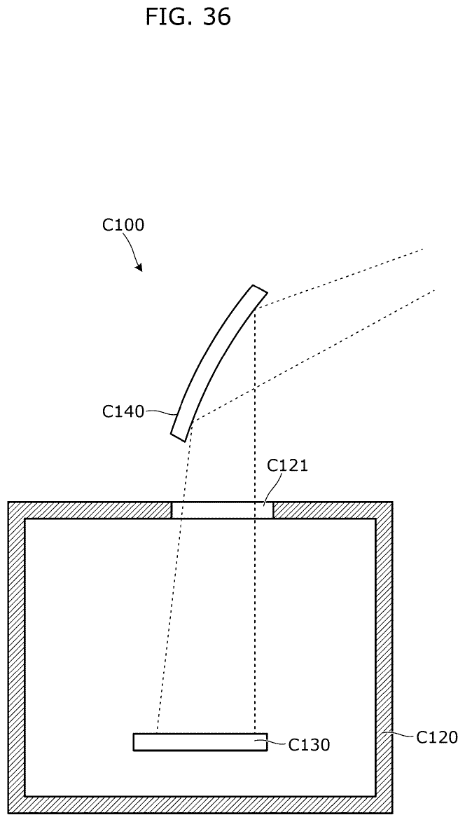

FIG. 36 is a schematic cross-sectional view showing display device C100 according to Embodiment 3. As shown in FIG. 36, display device C100 includes case C120, display element C130, and concave mirror C140.

Case C120 is a box-shaped body made of a light-shielding resin or metal. Case C120 has opening C121 at the upper end thereof. Through opening C121, the video light that serves as virtual display image C101 is projected upward. The internal space of case C120 houses display element C130.

Display element C130 is a liquid crystal panel, for example. Once a light source (not shown) projects light, display element C130 projects the video light that serves as virtual display image C101 toward opening C121. Display element C130 may be an organic EL panel. Display element C130 is oriented with the display surface facing upward.

Concave mirror C140 is an example of the optical system that is located above case C120 and reflects the video light emitted from display element C130 through opening C121, as virtual display image C101. Accordingly, the optical system includes a final reflective surface that is concave mirror C140. An example is described in this embodiment where only concave mirror C140 forms the optical system, a plurality of optical elements may form the optical system. Even if the optical system includes the optical elements, the final reflective surface may be a concave mirror. Note that concave mirror C140 may be provided on windshield CD1 of vehicle C1. In this case, concave mirror C140 may be bonded on to windshield CD1, or windshield CD1 itself may be concave mirror C140.

Concave mirror C140 is oriented to reflect the video light emitted from display element C130 toward the driver. That is, the video light reflected by concave mirror C140 heads for the eyes of the driver on the driver's seat, and serves as virtual display image C101. FIG. 35 shows a location of virtual display image C101 seen from the driver's point of view. This location can be set by adjusting the viewing distance of the video light projected from display element C130 of display device C100. The driver's point of view is the reference point of eyes, for example. The reference point of eyes is a point representing the position of the eyes of the driver in normal driving.

### Controller

As shown in FIG. 35, controller C500 is electrically connected to display device C100 and controls what is to be displayed by display element C130. Specifically, controller C500 includes a CPU, a RAM, and a ROM, for example, and executes various processing by the CPU developing and executing, in the RAM, the programs in the ROM.

Controller C500 is communicably connected to image capturer C3, which is included in vehicle C1 and captures an image of the surroundings of vehicle C1, through wired or wireless communication. Image capturer C3 may be included in display system C10.

Image capturer C3 includes a front camera for capturing an image of the front of vehicle C1, a rear camera for capturing an image of the rear of vehicle C1, a right side camera for capturing an image of the right side of vehicle C1, a left side camera for capturing an image of the left side of vehicle C1, and other suitable cameras. Here, the right side includes the right front and the right rear of vehicle C1, and the left side includes the left front and the left rear of vehicle C1. The right side images captured by the right side camera, and the left side images captured by the left side camera are each an example of the side image showing a side of vehicle C1.

Controller C500 causes display device C100 to display a part of an image obtained by image capturer C3 as a surrounding image in virtual display image C101.

### Virtual Display Image

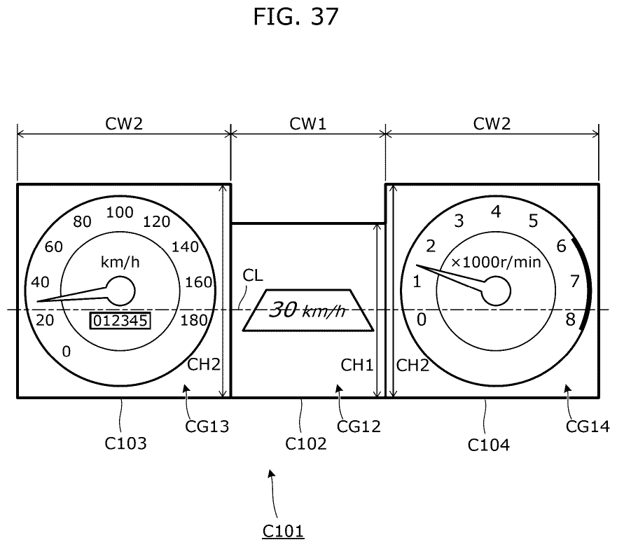

Now, virtual display image C101 will be described. FIG. 37 is a plan view showing virtual display image C101 according to Embodiment 3. FIG. 37 shows virtual display image C101 as seen from the driver. The center of virtual display image C101 in vehicle transverse direction almost matches the center of the user in a vehicle C1 (i.e., the center of the steering) in vehicle transverse direction. As shown in FIG. 37, virtual display image C101 continuously includes central area C102 of vehicle C1 in the vehicle transverse direction, and one-end area C103 and other-end area C104 in the vehicle transverse direction. Central area C102, one-end area C103 and other-end area C104 are each in a rectangular shape. One-end area C103 and other-end area C104 are in the same size, but central area C102 is in a different size. The lower end of central area C102 and the lower ends of one-end area C103 and other-end area C104 are aligned in a straight line. Accordingly, one-end area C103 and other-end area C104 overlaps horizontal line CL passing through the center of the height of central area C102.

First height CH1 of central area C102 is different from second height CH2 of one-end area C103 and other-end area C104. Specifically, second height CH2 is greater than first height CH1. Second length CW2 of one-end area C103 and other-end area C104 in the vehicle transverse direction is greater than first length CW1 of central area C102 in the vehicle transverse direction.

Here, FIG. 37 shows virtual display image C101 in normal driving. As shown in FIG. 37, controller C500 causes display device C100 to display what is to be displayed for normal driving in virtual display image C101 in normal driving. Specifically, controller C500 causes, for example, one-end area C103 to display vehicle speed meter CG13 in analog, central area C102 to display vehicle speed meter CG12 in digital, and other-end area C104 to display tachometer CG14 in analog. In this manner, in normal driving, one-end area C103 and other-end area C104 display meter images, such as vehicle speed meter CG13 and tachometer CG14.

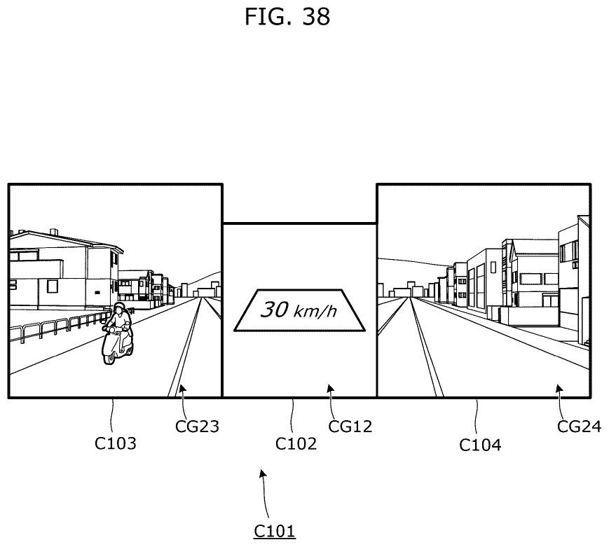

FIG. 38 is a plan view showing an example display when notification information appears in virtual display image C101 according to Embodiment 3. As shown in FIG. 38, controller C500 causes display device C100 to display what is to be displayed for the appearance of notification information in virtual display image C101 when notification information appears. Examples of the time “when notification information appears” include a time when a target of attention (e.g., another vehicle, a pedestrian, or an obstacle) approaches vehicle C1, and a time when the driver switches what is to be displayed. Specifically, controller C500 causes one-end area C103 to display left side image CG23 captured by the left side camera, central area C102 to display vehicle speed meter CG12 in digital, and other-end area C104 to display right side image CG24 captured by the right side camera.

At this time, controller C500 may cause the display device to display the side images as seen from the locations of one-end area C103 and other-end area C104 of virtual display image C101 in the one-end area and the other-end area. Here, one-end area C103 and left side image CG23 will be described as an example. Controller C500 recognizes, in advance, the coordinate position on which one-end area C103 is projected. Controller C500 performs imaging processing on left side image CG23 based on the coordinate position of controller C500 itself, the coordinate position of the left side camera, and the coordinate position of reference point of eyes. Controller C500 then creates a virtual left side image as seen from the driver at the location of one-end area C103. Controller C500 causes one-end area C103 to display the virtual left-side image. This can display the left-side image less strange for the driver.

### How to Form Outer Shape of Virtual Display Image

Now, how to form the outer shape of virtual display image C101 will be described. A technique using concave mirror C140 and a technique using display element C130 are raised to form the outer shape described above of virtual display image C101.

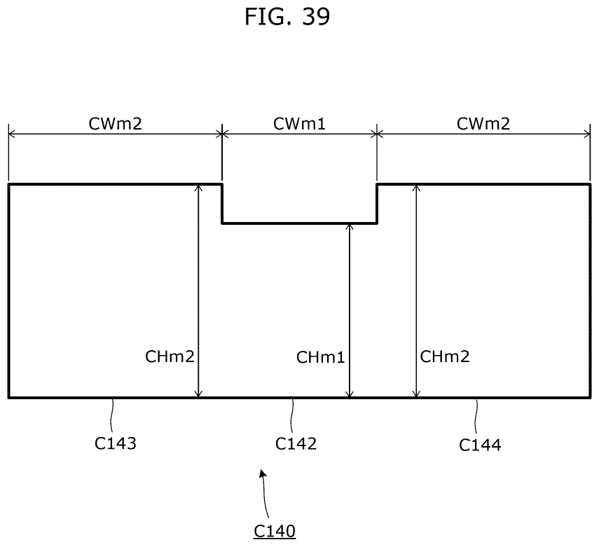

First, the technique using concave mirror C140 will be described. FIG. 39 is a plan view showing concave mirror C140 according to Embodiment 3. As shown in FIG. 39, the outer shape of concave mirror C140 corresponds to the outer shape of virtual display image C101. Specifically, concave mirror C140 includes central mirror area C142, one-end mirror area C143, and other-end mirror area C144 integrally. Central mirror area C142 corresponds to central area C102 of virtual display image C101, one-end mirror area C143 corresponds to one-end area C103 of virtual display image C101, and other-end mirror area C144 corresponds to other-end area C104 of virtual display image C101.

Central mirror area C142, one-end mirror area C143 and other-end mirror area C144 are each in a rectangular shape. one-end mirror area C143 and other-end mirror area C144 are in the same size, but central mirror area C142 is in a different size. The lower end of central mirror area C142 and the lower ends of one-end mirror area C143 and other-end mirror area C144 are aligned on the straight line.

First mirror height CHm1 of central mirror area C142 is different from second mirror height CHm2 of one-end mirror area C143 and other-end mirror area C144. Specifically, second mirror height CHm2 is greater than first mirror height CHm1. Second mirror length CWm2 of one-end mirror area C143 and other-end mirror area C144 in the vehicle transverse direction is greater than first mirror length CWm1 of central mirror area C142 in the vehicle transverse direction. When the video light is reflected by such concave mirror C140, virtual display image C101 in the shape described above can be formed without depending on the shape of display element C130.

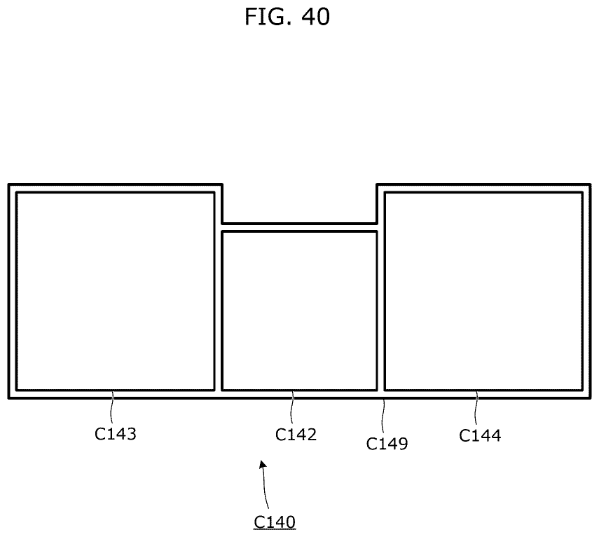

FIG. 40 is a plan view showing concave mirror C140 according to a variation of Embodiment 3. As shown in FIG. 40, concave mirror C140 may be divided into central mirror area C142, one-end mirror area C143, and other-end mirror area C144. In this case, central mirror area C142, one-end mirror area C143, and other-end mirror area C144 are held by one holding member C149.

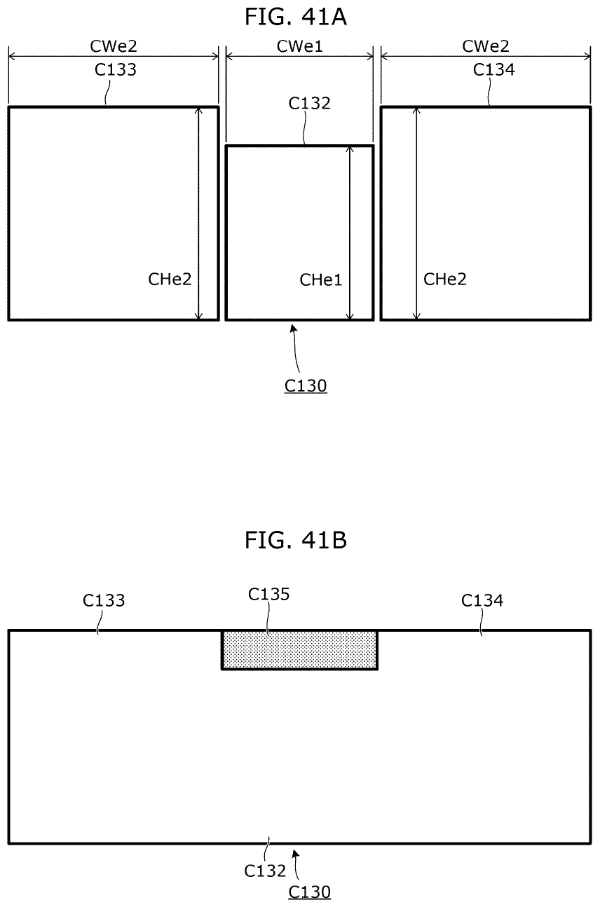

Next, the technique using display element C130 will be described. FIG. 41A is a plan view showing display element C130 according to Embodiment 3. As shown in FIG. 41A, the outer shape of display element C130 corresponds to the outer shape of virtual display image C101. Specifically, display element C130 is divided into central element C132 and a pair of end elements C133 and C134. Central element C132 is a display element (e.g., a liquid crystal element) corresponding to central area C102 of virtual display image C101, one end element C133 is a display element (e.g., a liquid crystal element) corresponding to one-end area C103 of virtual display image C101, and other end element C134 is a display element (e.g., a liquid crystal element) corresponding to other-end area C104 of virtual display image C101. Central element C132 and end elements C133 and C134 are each in a rectangular shape. End elements C133 and C134 are in the same size, but central element C132 is in a different size. The lower end of central element C132 and the lower ends of end elements C133 and C134 are aligned on a straight line.

First element height CHe1 of central element C132 is different from second element height CHe2 of end elements C133 and C134. Specifically, second element height CHe2 is greater than first element height CHe1. Second element length CWe2 of end elements C133 and C134 in the vehicle transverse direction is greater than first element length CWe1 of central element C132 in the vehicle transverse direction. When video light is emitted from such display element C130, virtual display image C101 in the shape described above can be formed without depending on the shape of concave mirror C140.

FIG. 41B is a plan view showing a variation of display element C130 according to Embodiment 3. As shown in FIG. 41B, display element C130 is as a whole in a rectangular shape, but the upper center (i.e., the dotted area) in the vehicle transverse direction is a non-display area controlled by controller C500. That is, central element C132 and a pair of end elements C133 and C134 are formed integrally. Due to non-display area C135, first element height CHe1 of central element C132 is different from second element height CHe2 of end elements C133 and C134.

### Advantages

As described above, in the embodiment described above, in virtual display image C101, first height CH1 of central area C102 and second height CH2 of one-end area C103 and other-end area C104 are different. This allows the driver to recognize the virtual image (e.g., vehicle speed meter CG12) displayed in central area C102 and the virtual images (e.g., vehicle speed meter CG13, tachometer CG14, left side image CG23, and right side image CG24) displayed in one-end area C103 and other-end area C104 as different virtual images. That is, virtual display image C101 projected by one display device C100 can be recognized by the driver as a plurality of virtual images, which can reduce an increase in the size of the whole system. In addition, the virtual image displayed in central area C102 and the virtual images displayed in one-end area C103 and other-end area C104 are included in virtual display image C101. This reduces the movement of the eyes of the driver and the focus adjustment. Further, first height CH1 of central area C102 and second height CH2 of one-end area C103 and other-end area C104 are different in virtual display image C101. As compared to the case of a display area in a rectangular shape as a whole, the driver can grasp virtual display image C101 displayed on one-end area C103 and other-end area C104 easily, while distinguishing the end areas from central area C102. Accordingly, the eyes of the driver is less likely to blocked. This can reduce the psychological burden on the driver. From the forgoing, display system C10 causing less burden on the driver can be provided, while reducing an increase in the size of the whole system.

Each of one-end area C103 and other-end area C104 displays a side image (e.g., left side image CG23 or right side image CG24) showing the corresponding side of vehicle C1. This allows the side image to be displayed as a virtual image and the driver to recognize the image.

Second height CH2 is greater than first height CH1. When being displayed in one-end area C103 and other-end area C104, side images can be displayed largely in the height direction. Accordingly, the driver can easily check the side images.

Second length CW2 of one-end area C103 and other-end area C104 in the vehicle transverse direction is greater than first length CW1 of central area C102 in the vehicle transverse direction. When being displayed in one-end area C103 and other-end area C104, side images can be displayed largely in the vehicle transverse direction. Accordingly, the driver can easily check the side images.

One-end area C103 and other-end area C104 overlaps horizontal line CL passing through the center of the height of central area C102. This allows the eyes of the driver to move linearly, when the driver views around whole virtual display image C101, which can reduce the burden on the driver.

In concave mirror C140, first mirror height CHm1 in central mirror area C142 may be different from second mirror height CHm2 in one-end mirror area C143 and other-end mirror area C144. Without employing any special display element, the shape of virtual display image C101 can be achieved by the shape of concave mirror C140.

Being divided into central mirror area C142, one-end mirror area C143, and other-end mirror area C144, concave mirror C140 can be manufactured easily, as compared to a concave mirror with an integral body.

Central mirror area C142, one-end mirror area C143, and other-end mirror area C144, which are separate bodies, are held by one holding member C149. This can hold central mirror area C142, one-end mirror area C143, and other-end mirror area C144 stably, and reduce the displacement of the optical axis in each area.

Concave mirror C140 is included in windshield CD1. Windshield CD1 can be used as a part of the optical system, which can downsize the system as a whole.

Display element C130 is divided into central element C132 corresponding to central area C102, and the pair of end elements C133 and C134 corresponding to one-end area C103 and other-end area C104. Accordingly, central element C132 and the pair of end elements C133 and C134 with simple outer shapes can be used.

Each of one-end area C103 and other-end area C104 displays the meter image in normal driving. On the other hand, when the notification information appears, each of one-end area C103 and other-end area C104 displays the side image. This can reduce the troubles of the side images displayed in one-end area C103 and other-end area C104 in normal driving.

One-end area C103 and other-end area C104 of virtual display image C101 display the side images as seen from the locations of one-end area C103 and other-end area C104. This can display the side images less strange for the driver.

### Variation 1

Variation 1 of Embodiment 3 will be described. In the following description, the same reference signs as in Embodiment 3 described above and other variations represent substantially the same parts, and the description thereof may be omitted.

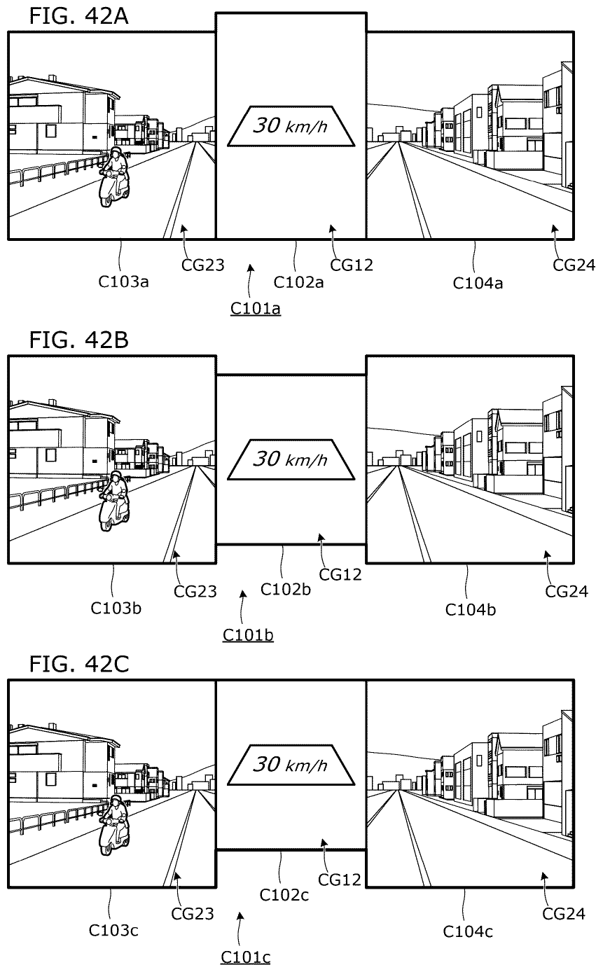

In Variation 1, example outer shapes of a virtual display image will be described. FIGS. 42A to 42C are each a plan view showing a virtual display image according to Variation 1 of Embodiment 3. In virtual display image C101a shown in FIG. 42A, the upper end of central area C102a is located higher than the upper ends of one-end area C103a and other-end area C104a. In virtual display image C101b shown in FIG. 42B, the upper end of central area C102b is lower than the upper ends of one-end area C103b and other-end area C104b. The lower end of central area C102b is higher than the lower ends of one-end area C103b and other-end area C104b. In virtual display image C101c shown in FIG. 42C, the ends of central area C102c, one-end area C103c, and other-end area C104c are aligned on a straight line. In each case, first height CH1 and second height CH2 are different.

### Variation 2

Variation 2 will be described. An example has been described above in Embodiment 3 where the center of virtual display image C101 in the vehicle transverse direction almost matches the center of the user in a vehicle C1 in the vehicle transverse direction. However, one of one-end area C103d or other-end area C104d of virtual display image C101d may be farther from the center of the driver in the vehicle transverse direction than the other is.

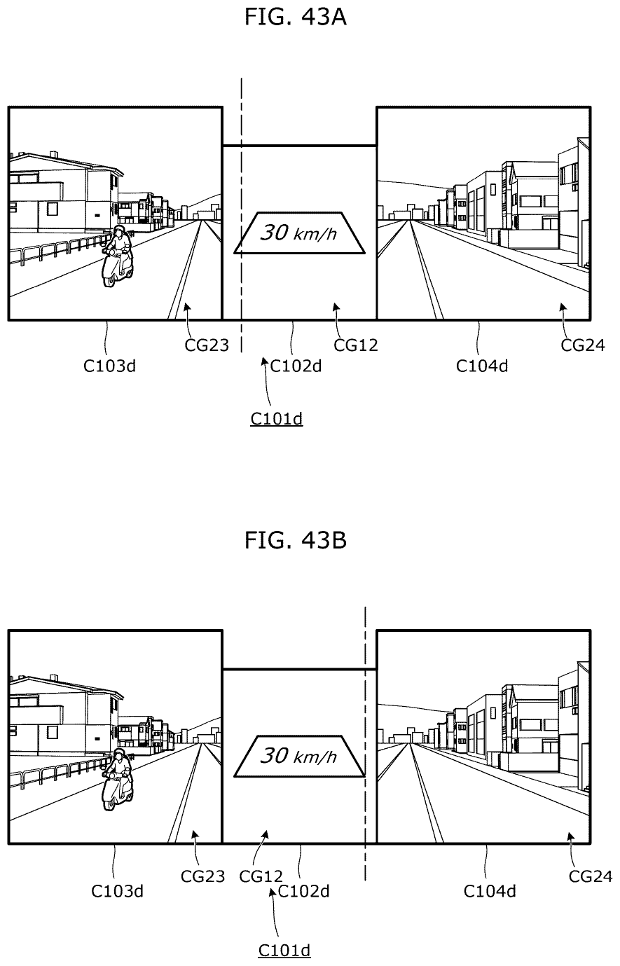

FIGS. 43A and 43B are plan views showing example arrangements of virtual display image C101d according to Variation 2 of Embodiment 3. FIG. 43A shows virtual display image C101d corresponding to left-handle drive (LHD) vehicle C1, while FIG. 43B shows virtual display image C101d corresponding to right-handle drive (RHD) vehicle C1. In FIGS. 43A and 43B, the dash-dotted line represents the center of the user in a vehicle C1 (i.e., the center of the steering) in the vehicle transverse direction.

As shown in FIG. 43A, in the case of LHD vehicle C1, virtual display image C101d is located such that one-end area C103d is closer to the center of the driver and other-end area C104d is farther from the center of the driver. Accordingly, virtual display image C101d is placed with a bias suitable for LHD vehicle C1, which enables the display of the image less strange for the driver.

As shown in FIG. 43B, in the case of RHD vehicle C1, virtual display image C101d is located such that one-end area C103d is farther from the center of the driver and other-end area C104d is closer to the center of the driver. Accordingly, virtual display image C101d is placed with a bias suitable for RHD vehicle C1, which enables the display of the image less strange for the driver.

### Variation 3

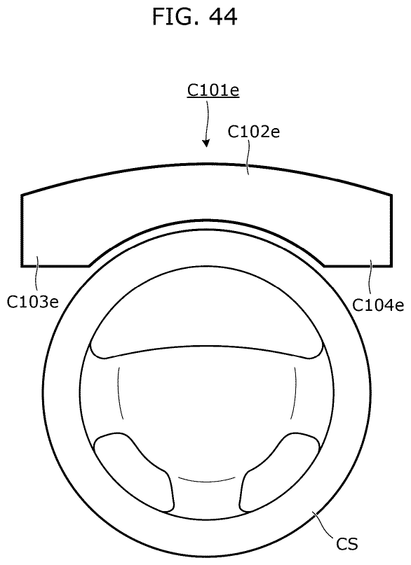

Variation 3 will be described. FIG. 44 is a plan view showing virtual display image C101e according to Variation 3 of Embodiment 3. As shown in FIG. 44, virtual display image C101e is located above steering CS of vehicle C1. The center of virtual display image C101e in the vehicle transverse direction almost matches the center of steering CS in the vehicle transverse direction. In virtual display image C101e, one-end area C103e and other-end area C104e protrude more downward than central area C102e does. Accordingly, steering CS is located between these downward protrusions of one-end area C103e and other-end area C104e beyond central area C102e, that is, in the non-display area. This can reduce the blockage of virtual display image C101e by steering CS.

Here, central area C102e of virtual display image C101e has a lower end in the shape along the upper shape of steering CS. In FIG. 44, the lower end of central area C102e is curved along the upper circular shape of steering CS as seen from the driver. In this manner, the lower end of central area C102e is curved along steering CS, which can reduce the area to be blocked by steering CS and make virtual display image C101e as large as possible. Note that the whole lower end of virtual display image C101e may be curved along steering CS. If steering CS is not in the circular shape but in a trapezoid shape, for example, as seen from the driver, central area C102e may have a lower end in a shape along the upper trapezoid shape of steering CS.

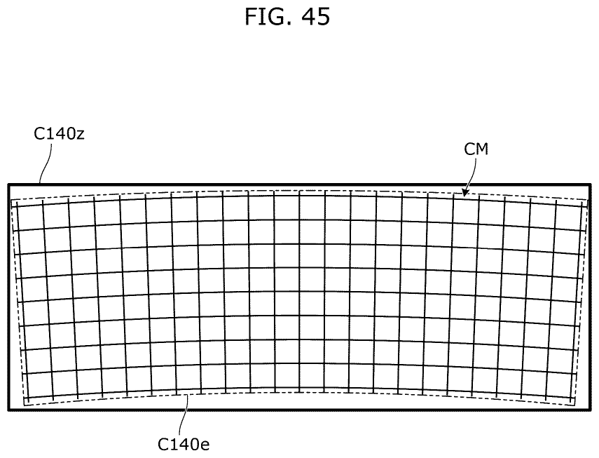

When the video light projected from planar display element C130 is reflected by a concave mirror, virtual display image C101e is distorted by the curve of the concave mirror. FIG. 45 is an illustration of the distortion of virtual display image C101e caused by the concave mirror according to Variation 3 of Embodiment 3. On display element C130, the box with a rectangular outer shape is reflected by concave mirror C140 and serves as box M with the center curved upward as shown in FIG. 45. For example, in the case of concave mirror C140z in a rectangular shape in plan view, there is an area (i.e., the area outside box M) not used for reflection. In this manner, the outer shape of concave mirror C140e may correspond to the outer shape of this box M so as to delete such the excessive part in advance. In particular, if at least concave mirror C140e has an upper end curved in a convex shape, concave mirror C140e can be made in a shape in view of the distortion.

### Variation 4

Now, Variation 4 will be described. In Variation 4, in concave mirror C140f, central mirror area C142f, one-end mirror area C143f, and other-end mirror area C144f have different curvatures. Specifically, each of one-end mirror area C143f and other-end mirror area C144f has a curvature greater than the curvature of central mirror area C142f. In this manner, each of one-end mirror area C143f and other-end mirror area C144f has a curvature greater than the curvature of central mirror area C142f. This can make one-end area C103 and other-end area C104 of virtual display image C101 larger than central area C102.

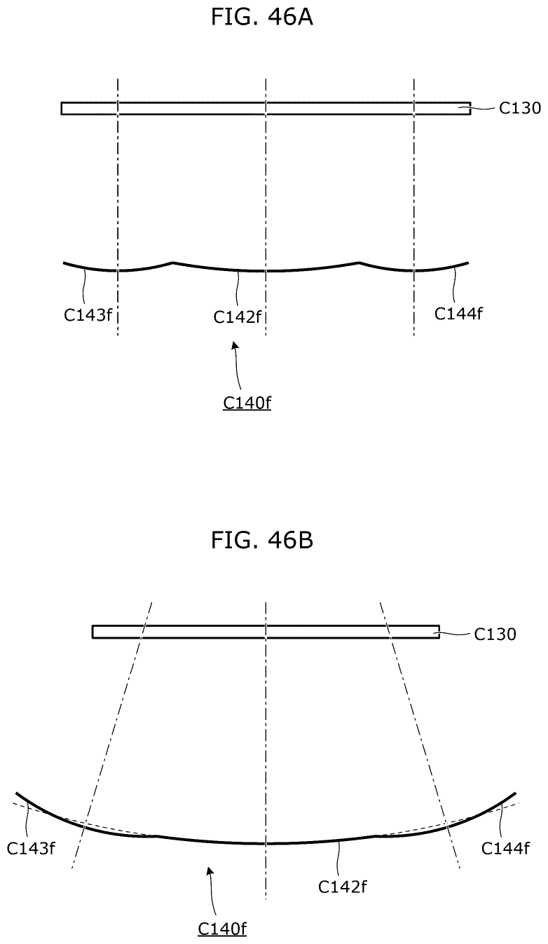

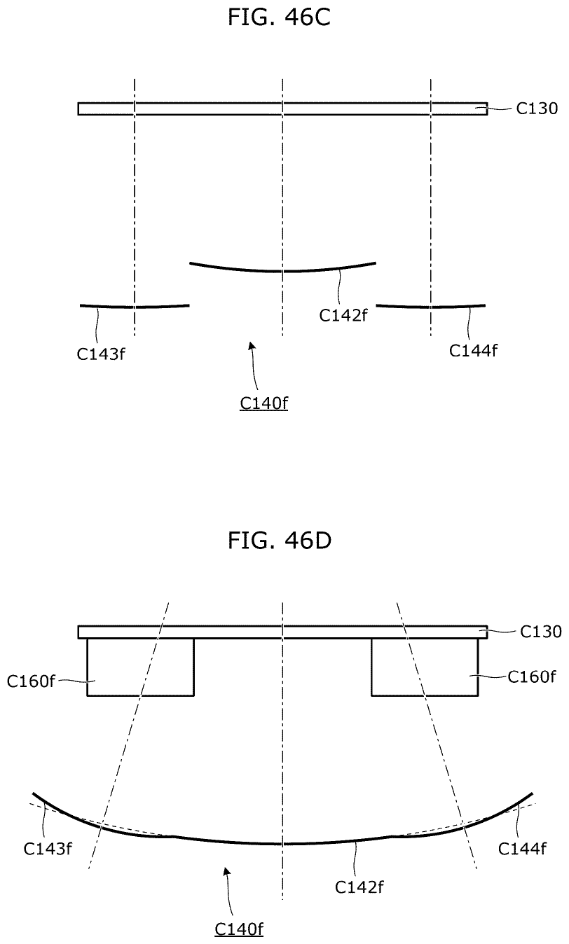

FIGS. 46A to 46D are each a schematic view showing central mirror area C142f, one-end mirror area C143f, and other-end mirror area C144f according to Variation 4 of Embodiment 3. FIGS. 46A to 46D show concave mirror C140f and display element C130 in a direction orthogonal to the optical axis.

In concave mirror C140f shown in FIG. 46A, central mirror area C142f, one-end mirror area C143f, and other-end mirror area C144f are arranged on a straight line. Each of one-end mirror area C143f and other-end mirror area C144f has a curvature greater than the curvature of central mirror area C142f.

In concave mirror C140f shown in FIG. 46B, central mirror area C142f, one-end mirror area C143f, and other-end mirror area C144f are arranged in an arc shape. Each of one-end mirror area C143f and other-end mirror area C144f has a curvature greater than the curvature of central mirror area C142f.

In concave mirror C140f shown in FIG. 46C, each of one-end mirror area C143f and other-end mirror area C144f has a curvature greater than the curvature of central mirror area C142f. Concave mirror C140f is divided into central mirror area C142f, one-end mirror area C143f, and other-end mirror area C144f. Specifically, one-end mirror area C143f and other-end mirror area C144f are at the same distance from display element C130. Central mirror area C142f is located closer to display element C130 than one-end mirror area C143f and other-end mirror area C144f are. Accordingly, the viewing distances of one-end area C103 and other-end area C104 of virtual display image C101 can be different from the viewing distance of central area C102.

In concave mirror C140f shown in FIG. 46D, central mirror area C142f, one-end mirror area C143f, and other-end mirror area C144f are aligned in an arc shape. Each of one-end mirror area C143f and other-end mirror area C144f has a curvature greater than the curvature of central mirror area C142f. In addition, light guide bodies 160f made of glass or a transparent resin are each interposed between one-end mirror area C143f and display element C130 or between other-end mirror area C144f and display element C130. On the other hand, no light guide body is interposed between central mirror area C142f and display element C130. Due to these light guide bodies 160f, the viewing distances from one-end area C103 and other-end area C104 of virtual display image C101 can be different from the viewing distance of central area C102.

### Variation 5

Now, variation 5 will be described. controller C500 may cause display device C100 to display side images in one-end area C103 and other-end area C104 of virtual display image C101 after being overlapped in a translucent manner by an interior image imitating the interior of vehicle C1.

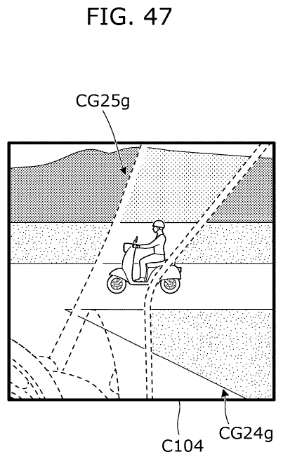

FIG. 47 is an illustration of an example display according to Variation 5 of Embodiment 3. FIG. 47 illustrates other-end area C104 of virtual display image C101. As shown in FIG. 47, other-end area C104 displays right side image CG24g captured by the right side camera and interior image CG25g imitating the interior in an overlapping manner. Interior image CG25g includes a pillar, for example. Interior image CG25g is translucent, which allows the user to intuitively grasp the positional relationship between the target of attention and the interior.

### Variation 6

Now, Variation 6 will be described. Controller C500 may cause display device C100 to display a side image showing a side of vehicle C1 in each of one-end area C103 and other-end area C104 of virtual display image C101 and display a rear image showing the rear of vehicle C1 in central area C102.

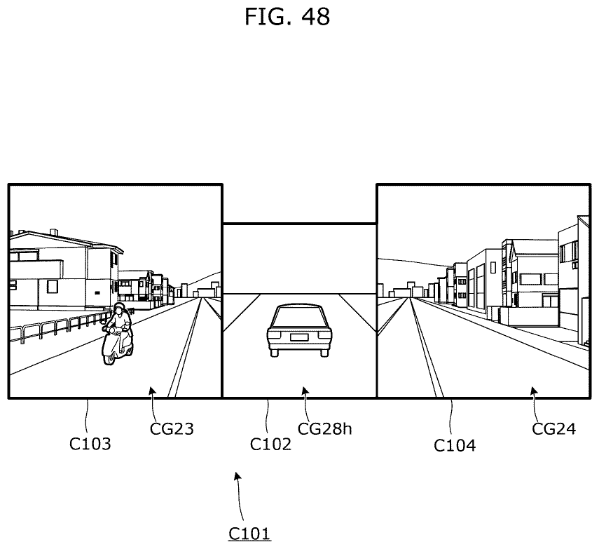

FIG. 48 is an illustration of an example display according to Variation 6 of Embodiment 3. As shown in FIG. 48, controller C500 causes one-end area C103 to display left side image CG23 captured by the left side camera, central area C102 to display rear image CG28h captured by the rear camera, and other-end area C104 to display right side image CG24 captured by the right side camera.

In this manner, each of one-end area C103 and other-end area C104 of virtual display image C101 displays a side image (i.e., left side image CG23 or right side image CG24), and central area C102 displays rear image CG28h. The side images and rear image CG28h can be displayed in a list, which allows the driver to grasp these images at once.

An example has been described above in Embodiment 3 where one-end area C103 displays vehicle speed meter CG13 in analog, central area C102 displays vehicle speed meter CG12 in digital, and other-end area C104 displays tachometer CG14 in analog in normal driving. However, controller C500 may cause display device C100 to turn off one-end area C103 and other-end area C104 of virtual display image C101 in normal driving. In this case, one-end area C103 and other-end area C104 are turned off in normal driving. This can reduce the troubles of the virtual images displayed in one-end area C103 and other-end area C104 in normal driving.

### (Others)

While the display system according to one or more aspects has been described above based on the embodiments, the present disclosure is not limited to the embodiments. The one or more aspects of the present disclosure may include forms obtained by various modifications to the foregoing embodiments that can be conceived by those skilled in the art or forms achieved by freely combining the elements in the foregoing embodiments without departing from the scope and spirit of the present disclosure.

### Further Information About Technical Background to this Application

The disclosures of the following patent applications including specification, drawings, and claims are incorporated herein by reference in their entirety: Japanese Patent Application No. 2024-210502 filed on Dec. 3, 2024, Japanese Patent Application No. 2024-210534 filed on Dec. 3, 2024, Japanese Patent Application No. 2024-210601 filed on Dec. 3, 2024, and Japanese Patent Application No. 2025-120604 filed on Jul. 17, 2025.

### Industrial Applicability

The present disclosure is applicable as a display system for displaying virtual images.

1. A display system comprising:
a first display device that displays a first virtual display image in front of a user in a vehicle; and
a controller that controls the first display device, wherein the first display device includes:
a display element that emits video light that serves as the first virtual display image; and
a reflector that forms the first virtual display image by reflecting the video light from the display element toward the user,
the display element includes:
a whole display area wider than a display area corresponding to a field of view of the reflector;
a first area as a reference in the whole display area; and
a second area including, in the whole display area:
a superimposed section at least partially overlapping the first area; and
a non-superimposed section extending beyond the first area, and
the controller causes the first display device to be switched between:
a first state to form the first virtual display image only in the first area; and
a second state to form the first virtual display image in the first area and the second area, or only in the second area.

2. The display system according to claim 1, wherein
the second area extends beyond the first area in at least one of an upward, downward, right, or left direction.

3. The display system according to claim 1, wherein
the controller causes the first display device to display a speedometer in the first area in each of the first state and the second state.

4. The display system according to claim 1, wherein
the controller causes the first display device to display, in the second state:
a frame image showing a side mirror frame of the vehicle in the second area; and
a rear image showing a rear of the vehicle in an area corresponding to a mirror in the frame image in the second area.

5. The display system according to claim 1, wherein
the controller causes the first display device to display, in the second state, a front image showing a front of the vehicle in the second area.

6. The display system according to claim 1, wherein
the controller causes the first display device to display, in the second state, a pillar image overlapping a surrounding image in the second area, the pillar image showing a pillar of the vehicle, the surrounding image being an image captured by a camera outside the pillar.

7. The display system according to claim 1, further comprising:
a second display device that displays a second virtual display image in front of the user and above or below the first virtual display image, wherein
the controller causes the first display device and the second display device to display an arrow extending across the first virtual display image and the second virtual display image.

8. The display system according to claim 1, further comprising:
a viewpoint detector that detects a point of view of the user, wherein
the controller causes the first display device to operate in:
the second state, when the point of view detected by the viewpoint detector is within a predetermined area; and
the first state, when the point of view detected by the viewpoint detector is out of the predetermined area.

9. The display system according to claim 4, wherein
the controller causes the first display device to display, in the second area, a guide mark for guiding eyes of the user toward a target of attention included in the rear image.

10. The display system according to claim 1, further comprising:
a second display device that displays a second virtual display image in front of the user and above the first virtual display image; and
an image capturer that captures an image of surroundings of the vehicle, wherein
the controller controls the second display device and the image capturer, and
the controller causes:
the first display device to display, in the first virtual display image, vehicle surrounding information obtained by the image capturer; and
the second display device to display, in the second virtual display image, first guide information for encouraging guiding of eyes to the first virtual display image, and
the controller subsequently causes:
the first display device to display, in the first virtual display image, second guide information for encouraging guiding of eyes to the front of the vehicle.

11. The display system according to claim 10, wherein
when displaying the second guide information in the first virtual display image, the controller causes the second display device to display, in the second virtual display image, third guide information for encouraging the guiding of eyes to the front of the vehicle.

12. The display system according to claim 11, wherein
the controller causes the second display device to display the third guide information in the second virtual display image to guide the eyes to a target of attention in front of the vehicle.

13. The display system according to claim 11, wherein
when displaying at least one of the second guide information or the third guide information, the controller causes the first display device to display the vehicle surrounding information in the first virtual display image.

14. The display system according to claim 10, wherein
when determining that a target of attention in front of the vehicle is not in a blind spot for the user based on the vehicle surrounding information, the controller causes the first display device not to display the vehicle surrounding information in the first virtual display image.

15. The display system according to claim 1, wherein
in the first virtual display image, a first height in a central area in a vehicle transverse direction of the vehicle is different from a second height in a one-end area and an other-end area in the vehicle transverse direction.

16. The display system according to claim 15, wherein
the controller causes the first display device to display a side image showing a side of the vehicle in each of the one-end area and the other-end area in the first virtual display image.

17. The display system according to claim 15, wherein
the second height is greater than the first height.

18. The display system according to claim 15, wherein
the first display device further includes:
a display element that generates the video light that serves as the first virtual display image; and
an optical system that reflects the video light emitted from the display element to form the first virtual display image,
the optical system includes a final reflective surface that is a concave mirror, and
in the concave mirror, a first mirror height in a central mirror area in the vehicle transverse direction is different from a second mirror height in a one-end mirror area and an other-end mirror area in the vehicle transverse direction.

19. The display system according to claim 18, wherein
the concave mirror is included in a windshield of the vehicle.

20. The display system according to claim 15, wherein
the first display device further includes:
a display element that generates the video light that serves as the first virtual display image; and
an optical system that reflects the video light emitted from the display element to form the first virtual display image, and
the display element is divided into:
a central element corresponding to the central area in the first virtual display image; and
a pair of end elements corresponding to the one-end area and the other-end area in the first virtual display image.
